(19) United States
(12) Patent Application Publication
(10) Pub. No.: US 2026/0169135 A1
(43) Pub. Date: Jun. 18, 2026

(54) SELECTIVE OPERATION OF A SENSING UNIT OF A LIDAR SYSTEM

(71) Applicant: INNOVIZ TECHNOLOGIES LTD., Rosh Ha'ayin (IL)

(72) Inventors: David COHEN, Nesher (IL); Ronen ESHEL, Herzliya (IL); Idan BAKISH, Hod Hasharon (IL); Ran MOR, Herzliya (IL); Elchanan SHAPIRA, Kedumim (IL)

(21) Appl. No.: 19/119,806

(22) PCT Filed: Oct. 18, 2023
(86) PCT No.: PCT/IB2023/060531

§ 371 Date: Apr. 10, 2025

Related U.S. Application Data
(60) Provisional application No. 63/380,052, filed on Oct. 18, 2022.
(60) Provisional application No. 63/386,500, filed on Dec. 8, 2022.

(51) Int. Cl. G01S 7/481; G01S 17/931

(52) U.S. Cl. CPC G01S 7/4816; G01S 17/931

(57) ABSTRACT

A LIDAR system that includes optics configured to (a) transmit, using a scanner, a transmitted signal, and (b) receive, using the scanner, reflections from objects, during a scan segment time window that corresponds to a scan segment of a field of view (FOV) of the LIDAR system; a sensing unit that includes multiple sensing elements; and a controller that is arranged to (a) activate the multiple sensing elements before starting to receive the reflections, and (b) selectively deactivate at least some of the multiple sensing elements, based on a scan direction of the scan segment, thereby reducing a number of active sensing elements during the scan segment time window.

### CROSS REFERENCE

This application claims priority from U.S. provisional patent Ser. No. 63/380,052 filing date 18 Oct., 2022—which is incorporated herein in its entirety.

This application claims priority from U.S. provisional patent serial number 63/386,5000 filing date 8 Dec., 2022—which is incorporated herein in its entirety.

### BACKGROUND

The present disclosure relates generally to surveying technology for scanning a surrounding environment, and, more specifically, to systems and methods that use LIDAR technology to detect objects in the surrounding environment.

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions including, rain, fog, darkness, bright light, and snow. A light detection and ranging system, (LIDAR a.k.a LADAR) is an example of technology that can work well in differing conditions, by measuring distances to objects by illuminating objects with light and measuring the reflected pulses with a sensor. A laser is one example of a light source that can be used in a LIDAR system. As with any sensing system, in order for a LIDAR-based sensing system to be fully adopted by the automotive industry, the system should provide reliable data enabling detection of far-away objects.

The systems and methods of the present disclosure are directed towards improving the performance of LIDAR systems.

### SUMMARY

Methods, LIDAR systems, and non-transitory computer readable medium as substantially illustrated in the application.

### BRIEF DESCRIPTION

The accompanying drawings, which are incorporated in and constitute a part of this disclosure, illustrate various disclosed embodiments. In the drawings:

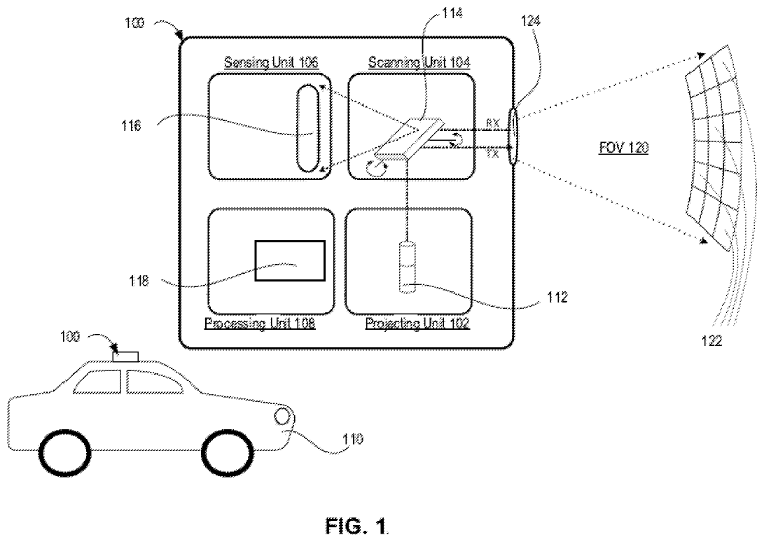

FIG. 1 illustrates an example of a LIDAR system;

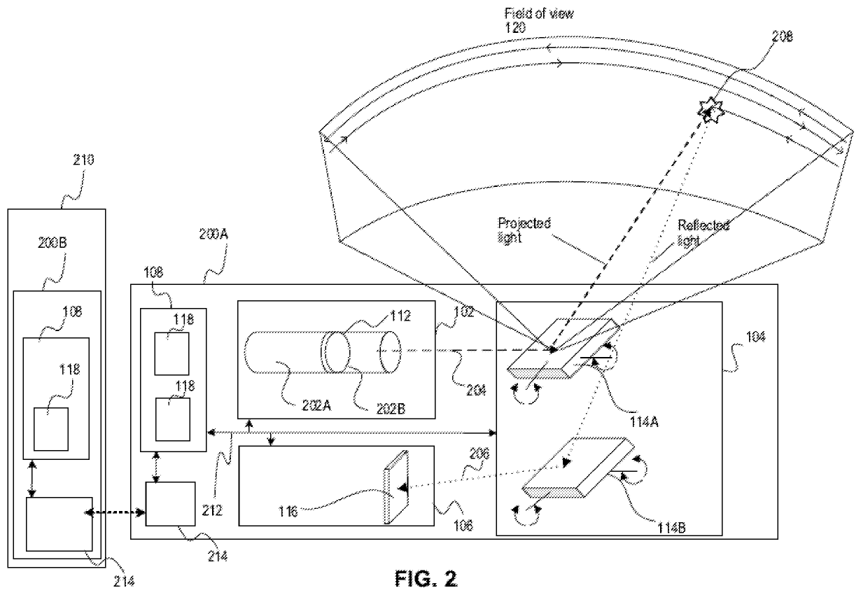

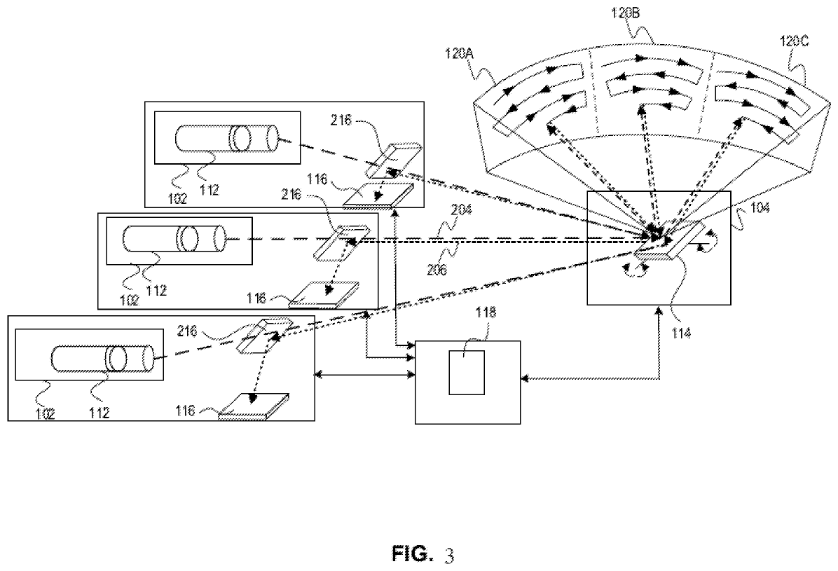

FIGS. 2 and 3 illustrate various configurations of a projecting unit and its role in a LIDAR system;

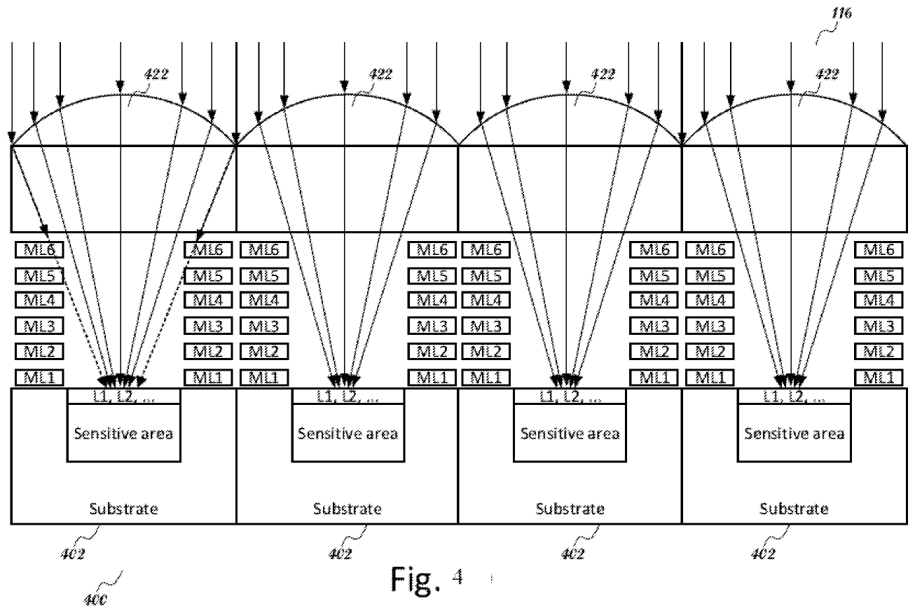

FIG. 4 is a cross cut diagram of a part of a sensor;

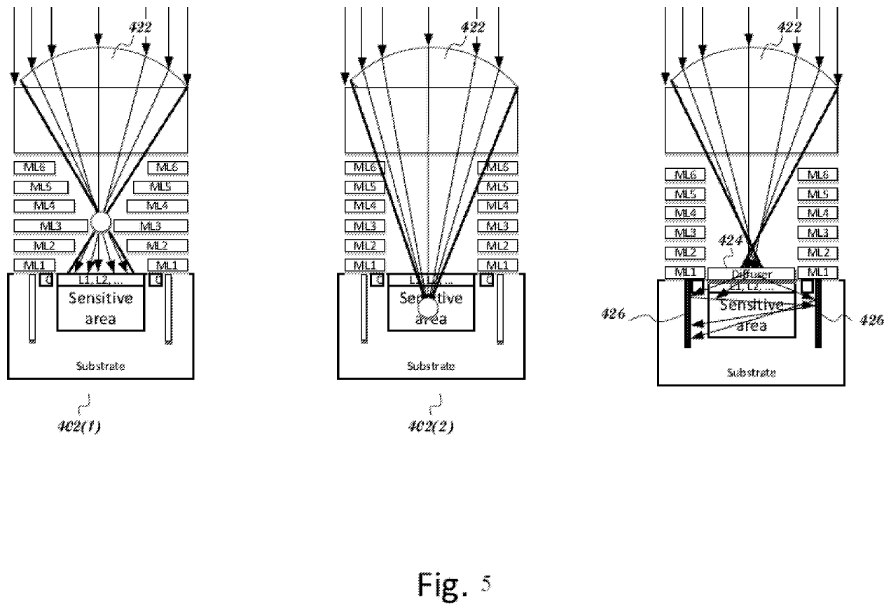

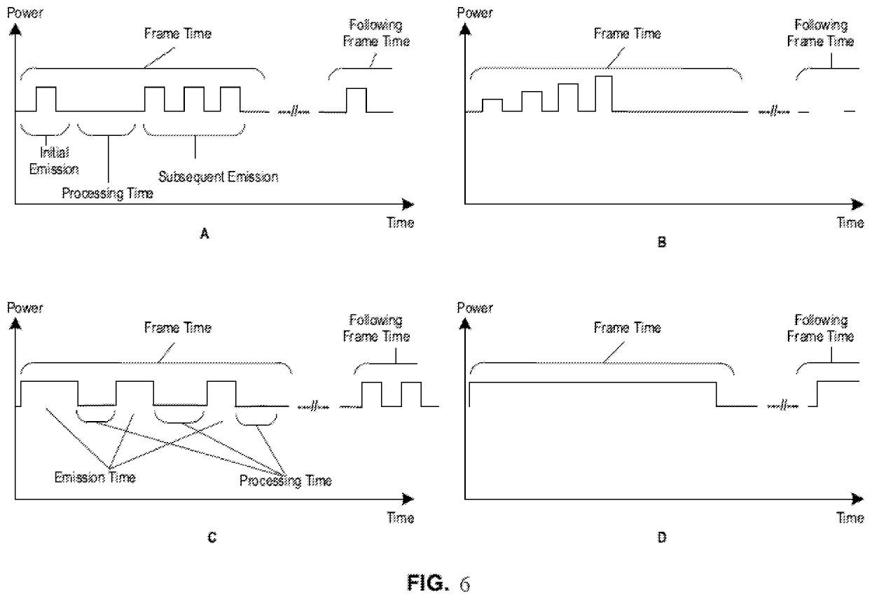

FIGS. 5 and 6 depict various configurations of a sensing unit and its role in a LIDAR system;

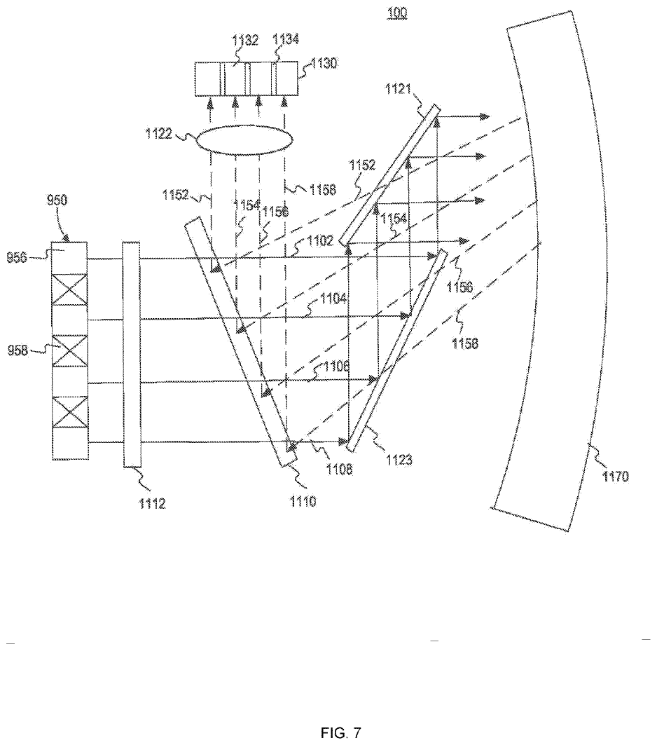

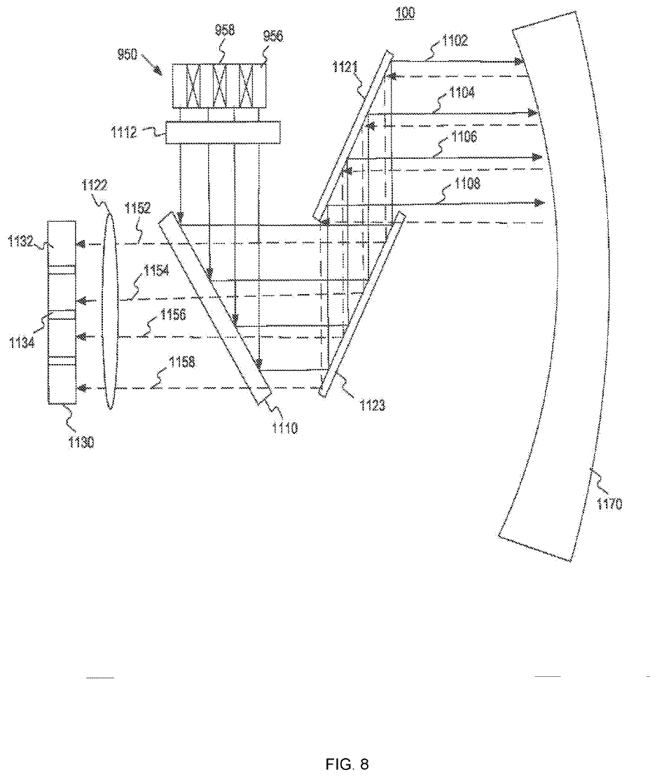

FIGS. 7-8 illustrate examples of LIDARs;

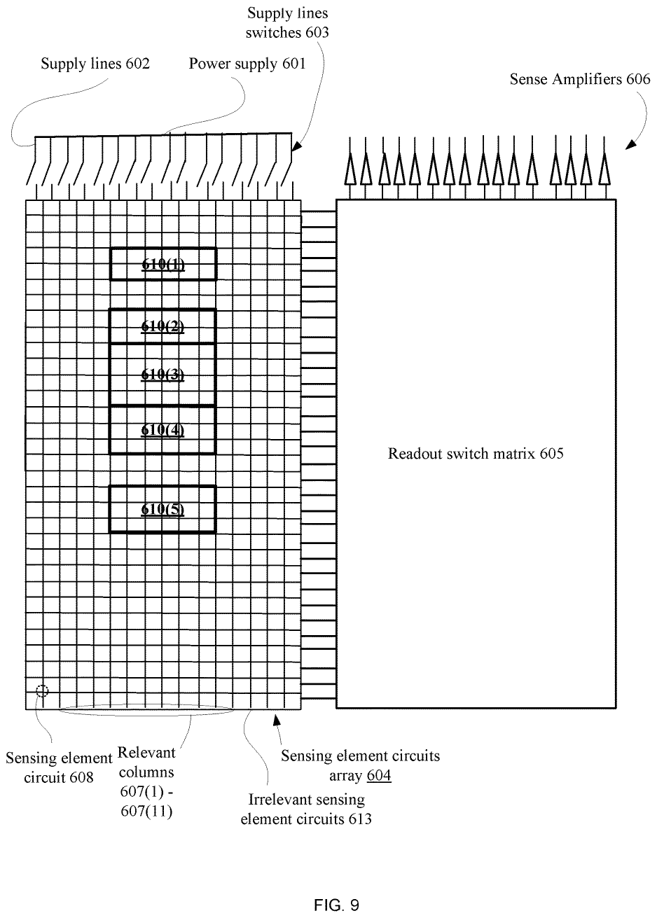

FIG. 9 illustrates an example of an array of sensing element circuits, a readout circuit and horizontally aligned reception windows;

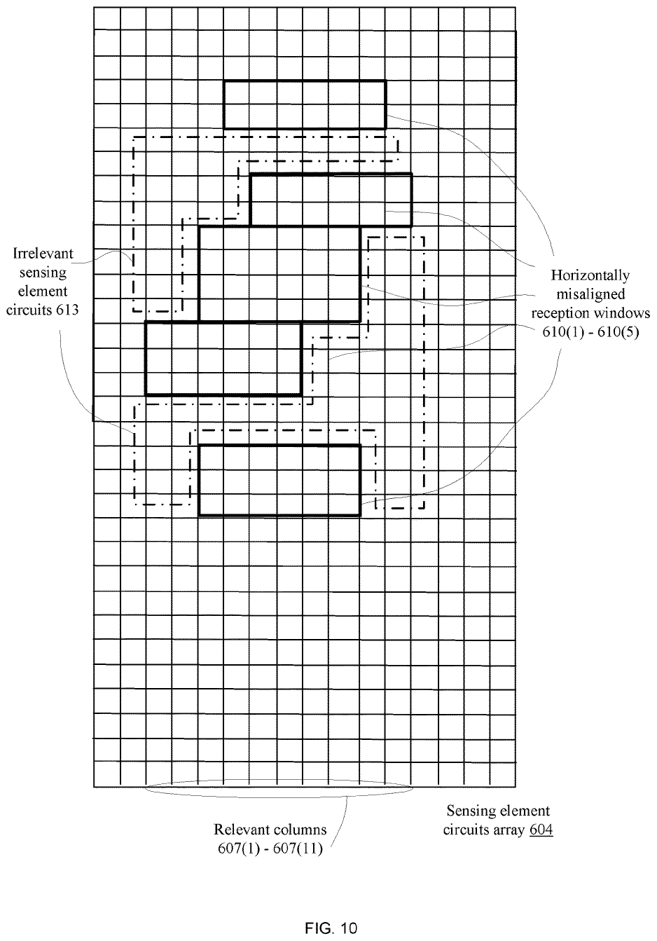

FIG. 10 illustrates an example of an array of sensing element circuits, a readout circuit and horizontally misaligned reception windows;

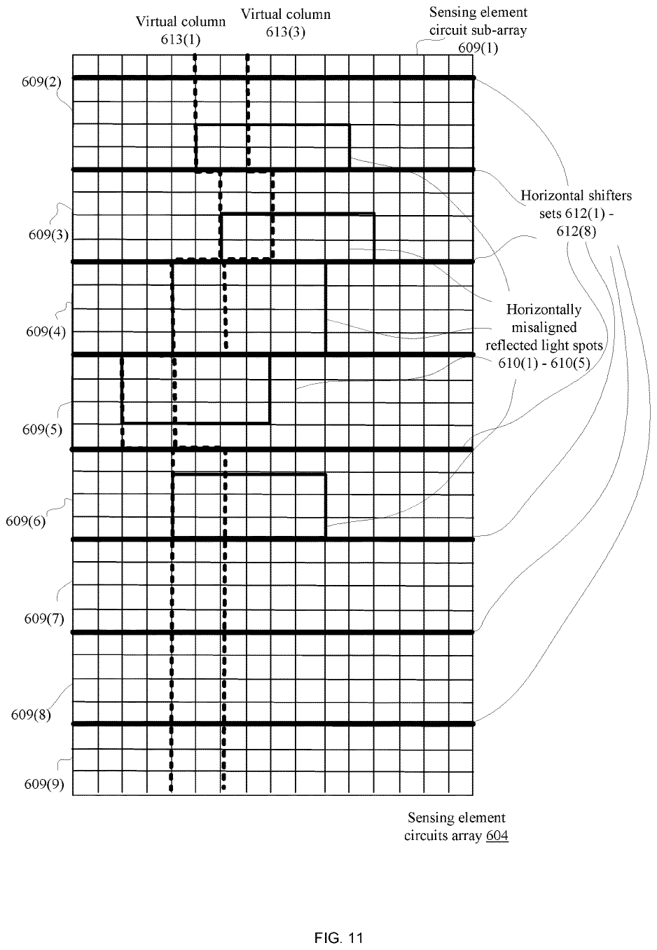

FIG. 11 illustrates an example of an array of sensing element circuits, horizontal shifting element sets and horizontally misaligned reception windows;

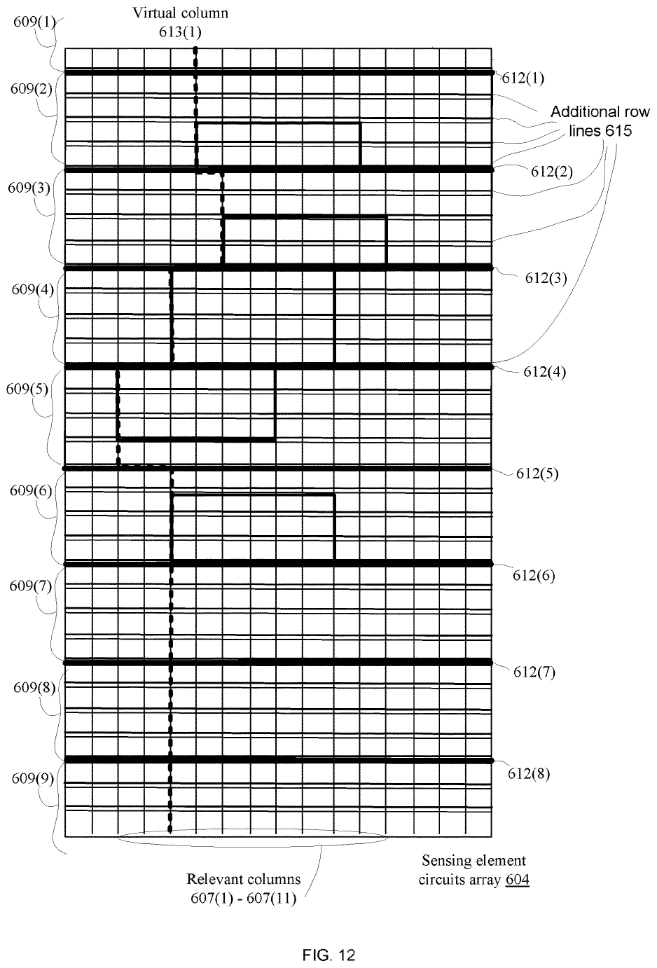

FIG. 12 illustrates an example of an array of sensing element circuits, horizontal shifting element sets, multiple row output lines, and horizontally misaligned reception windows;

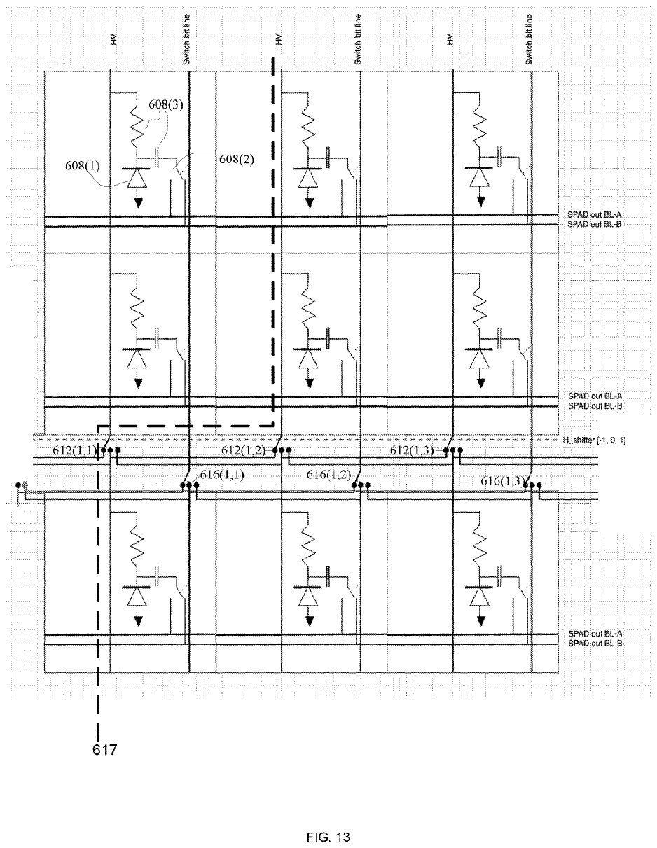

FIG. 13 illustrates an example of sensing element circuits and horizontal shifting elements;

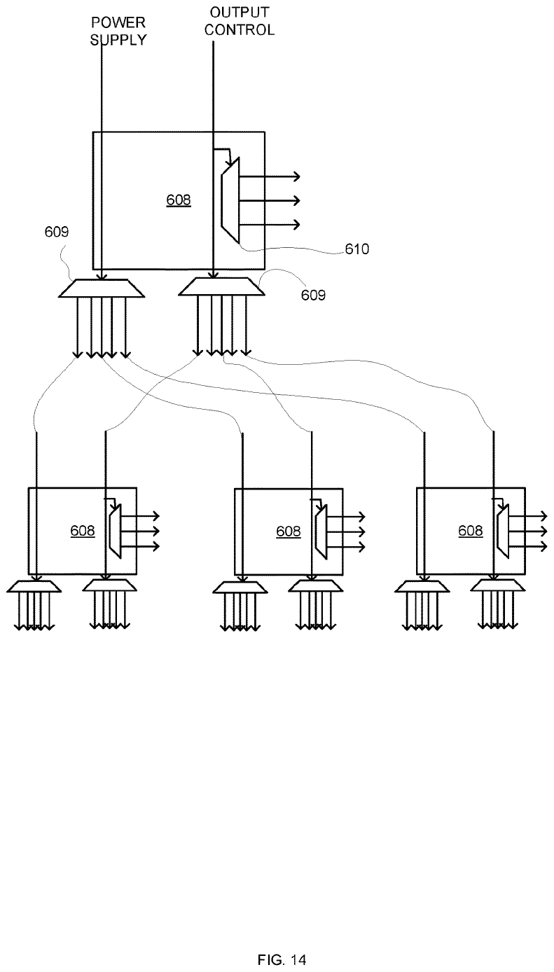

FIG. 14 illustrates an example of sensing element circuits and horizontal shifting elements;

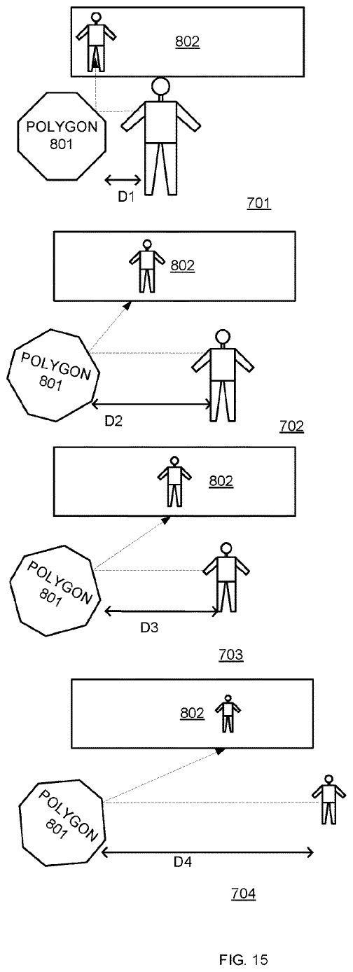

FIG. 15 illustrates an example of a relationship between a distance of a target from the LIDAR, a rotation of a polygon and the horizontal location of the target within a reception window

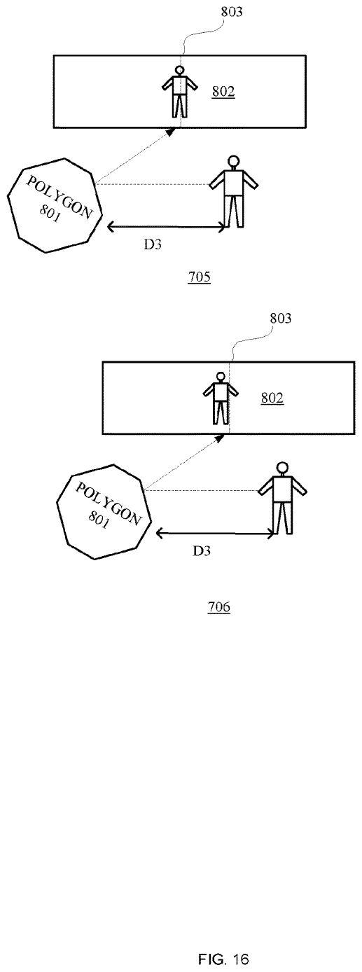

FIG. 16 illustrates an aligned scene and a misaligned scene;

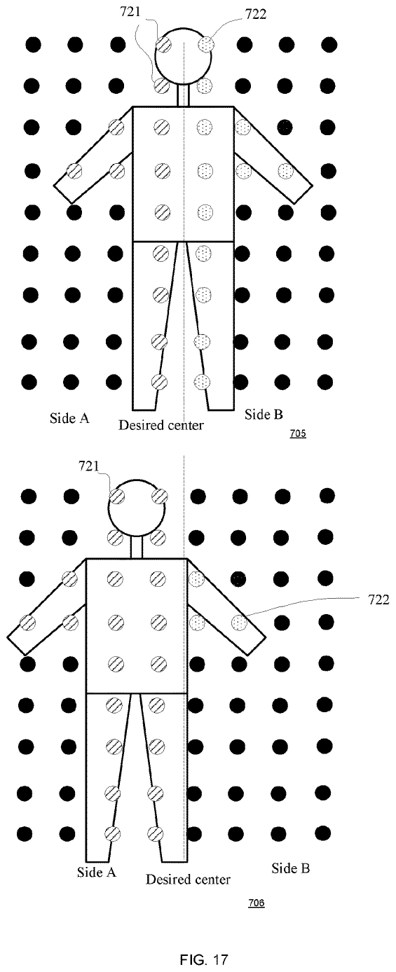

FIG. 17 illustrates side A sensing element circuits and side B sensing element circuits;

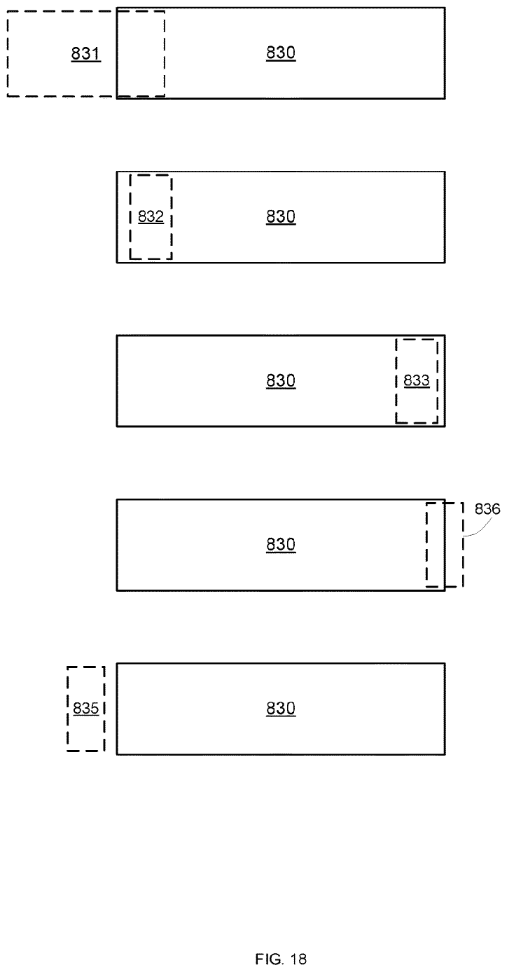

FIG. 18 is an example of a reduced sensing window at different points in time;

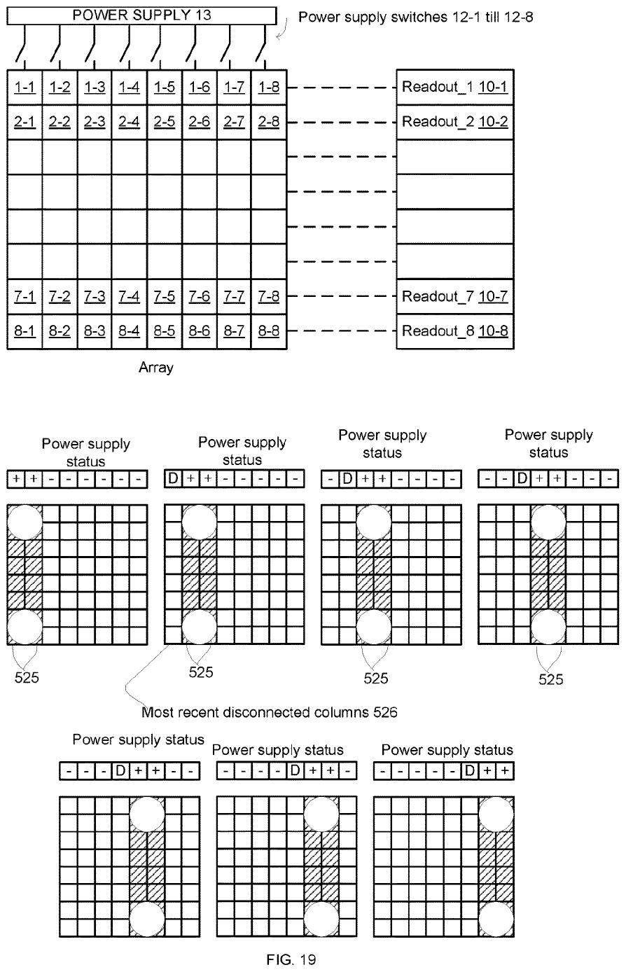

FIG. 19 is an example of a sensing unit and additional circuitry;

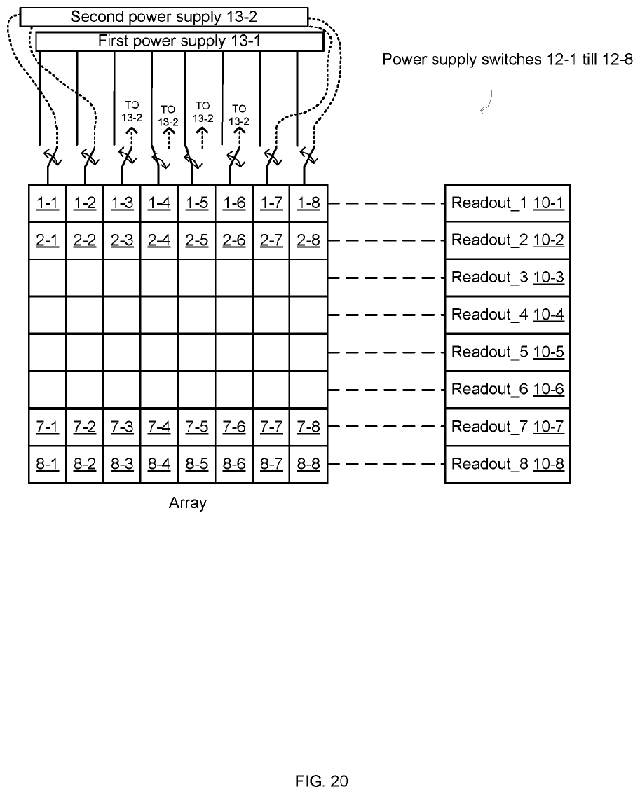

FIG. 20 is an example of a sensing unit and additional circuitry;

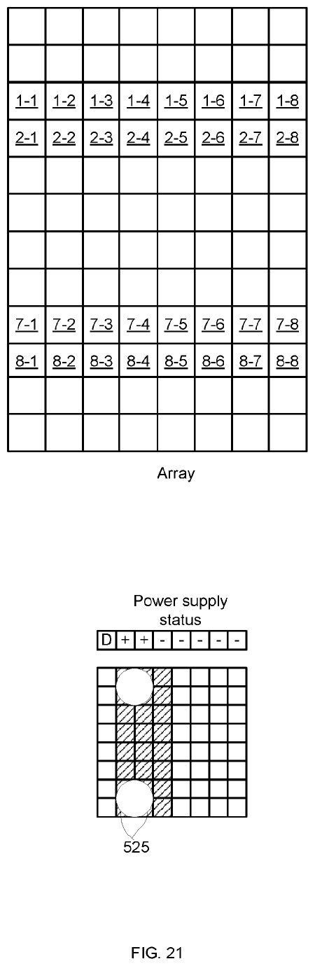

FIG. 21 is an example of a sensing unit;

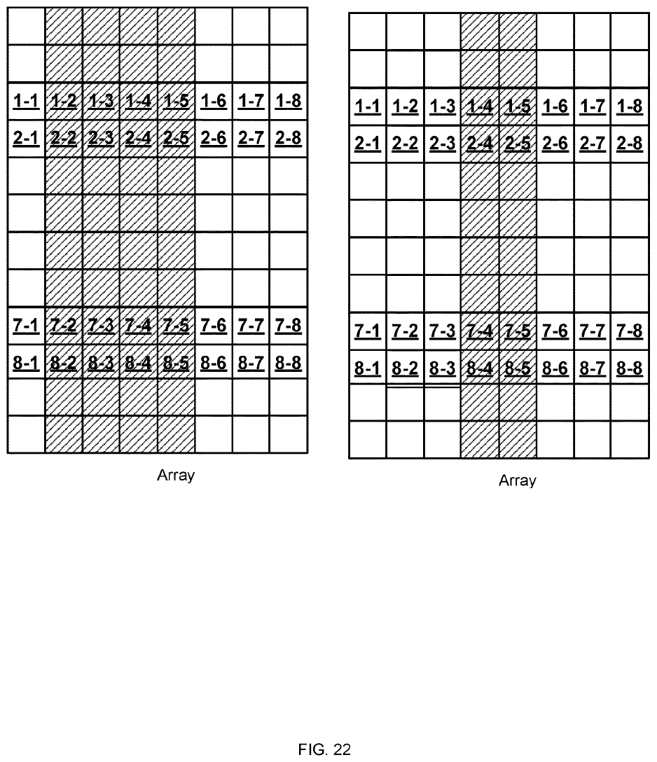

FIG. 22 is an example of a sensing unit;

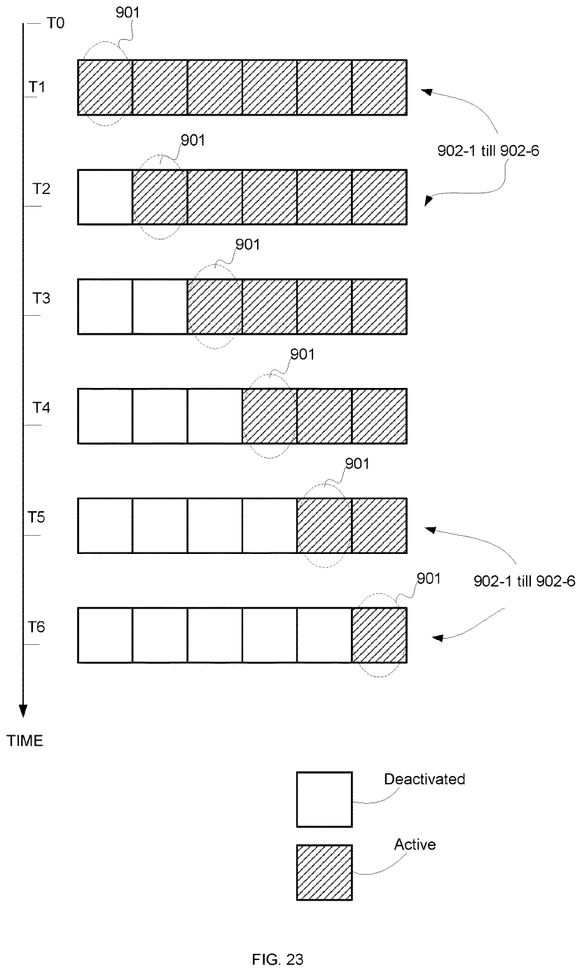

FIG. 23 is an example of a reflection and a row of groups of sensing elements at different points in time;

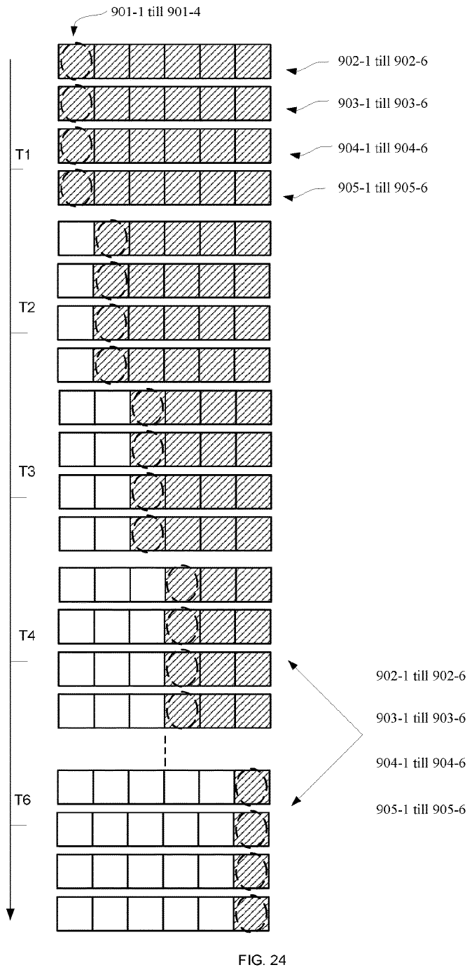

FIG. 24 is an example of reflections and sets of sensing elements at different points in time;

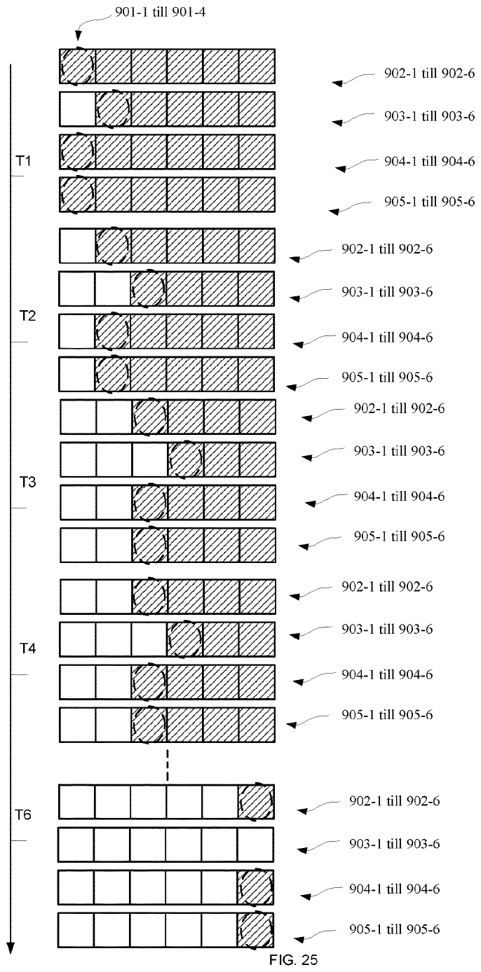

FIG. 25 is an example of reflections and sets of sensing elements at different points in time;

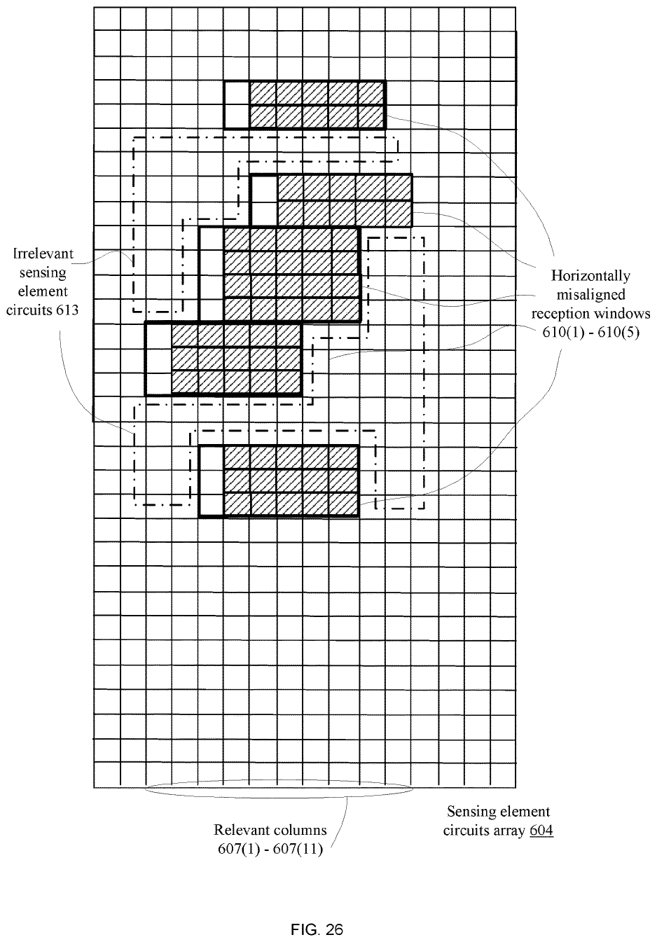

FIG. 26 is an example of sets of sensing elements at different points in time;

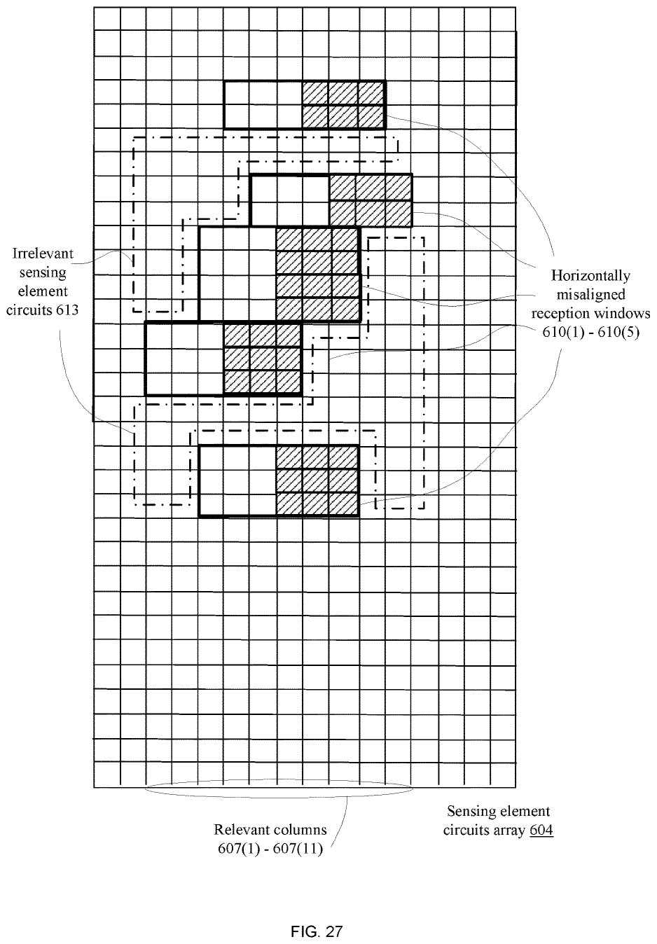

FIG. 27 is an example of sets of sensing elements at different points in time;

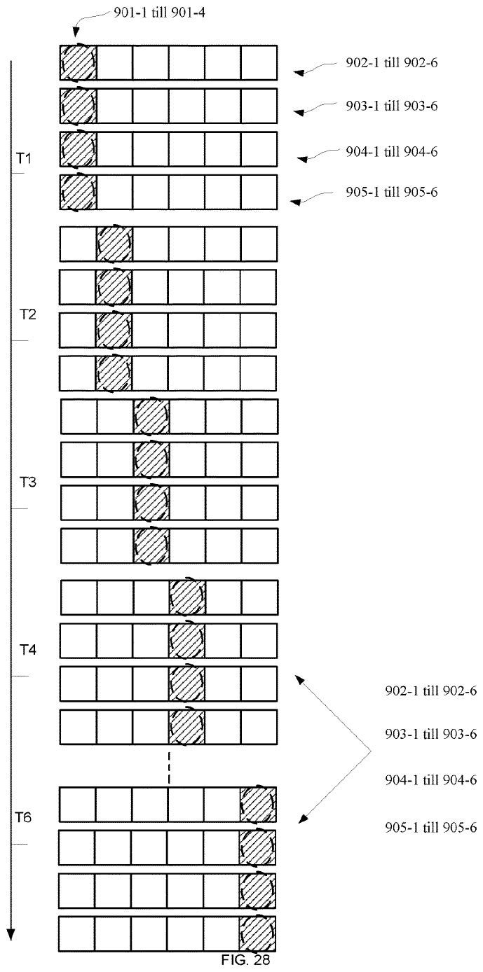

FIG. 28 is an example of reflections and sets of sensing elements at different points in time;

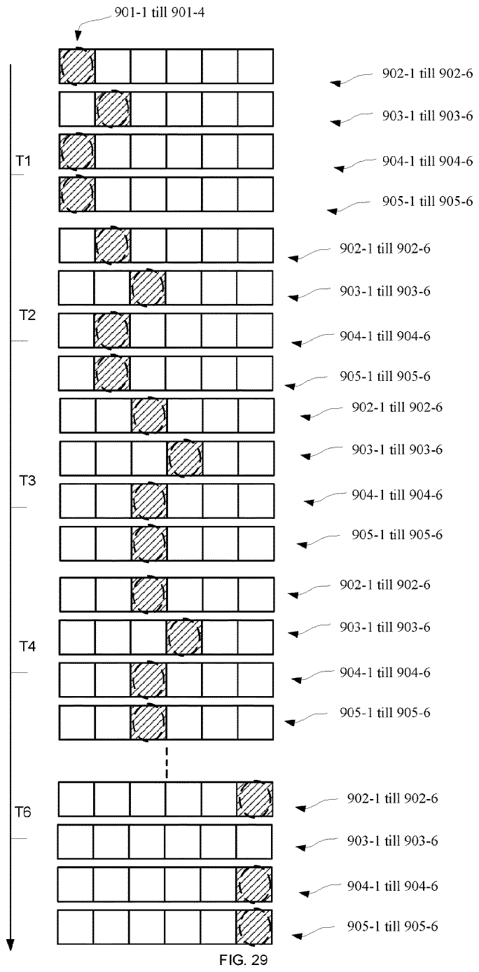

FIG. 29 is an example of reflections and sets of sensing elements at different points in time;

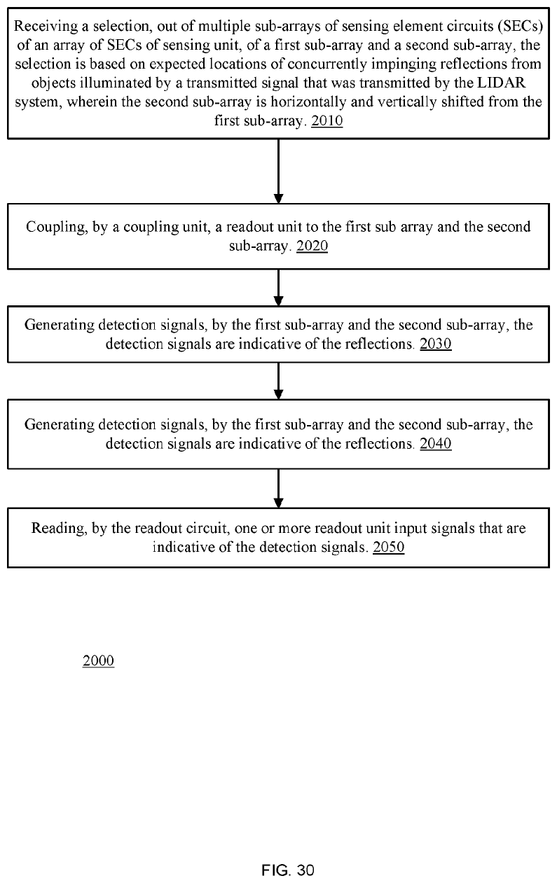

FIG. 30 is an example of a method;

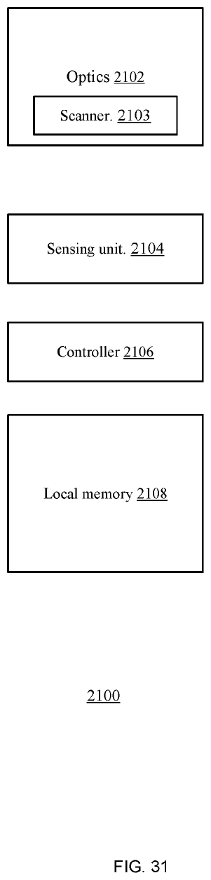

FIG. 31 is an example of a LIDAR system;

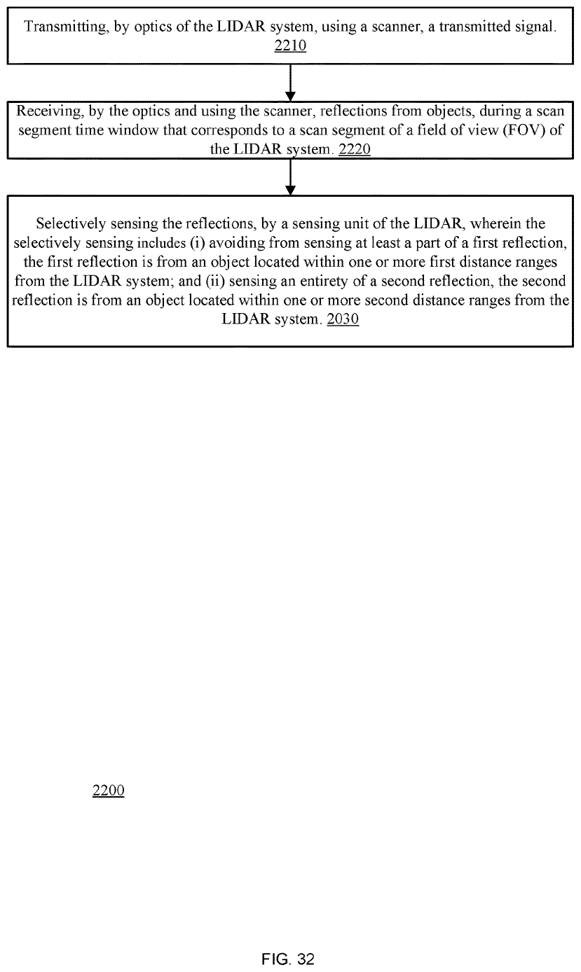

FIG. 32 is an example of a method;

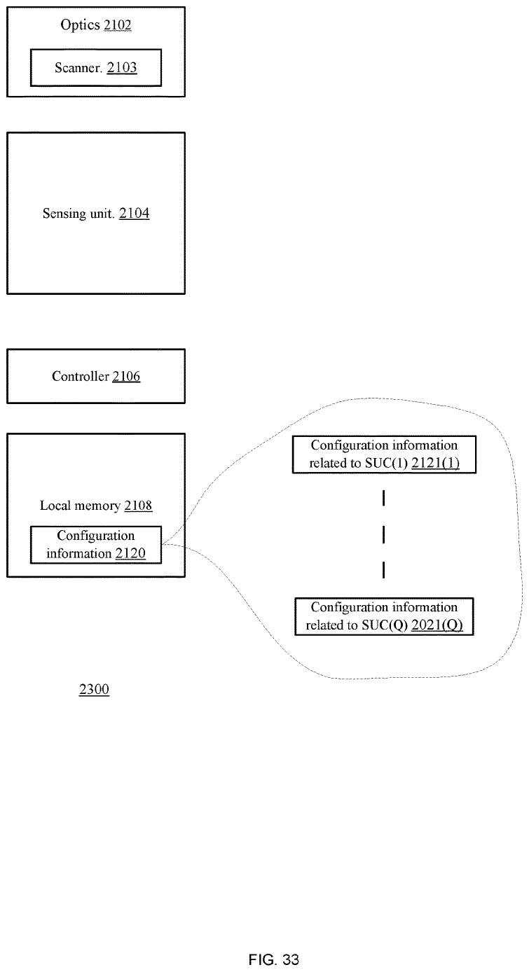

FIG. 33 is an example of a LIDAR system;

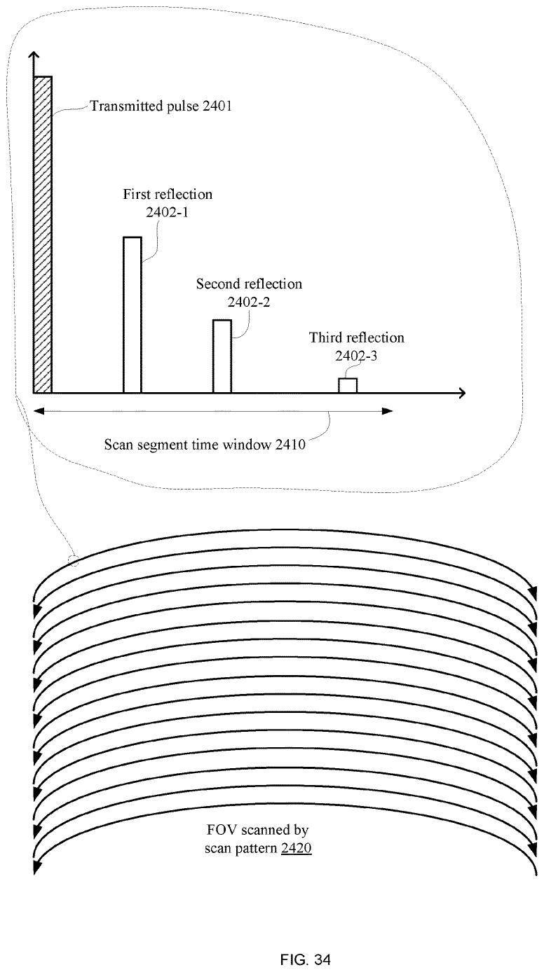

FIG. 34 is an example of a scan pattern and of a scan segment time window;

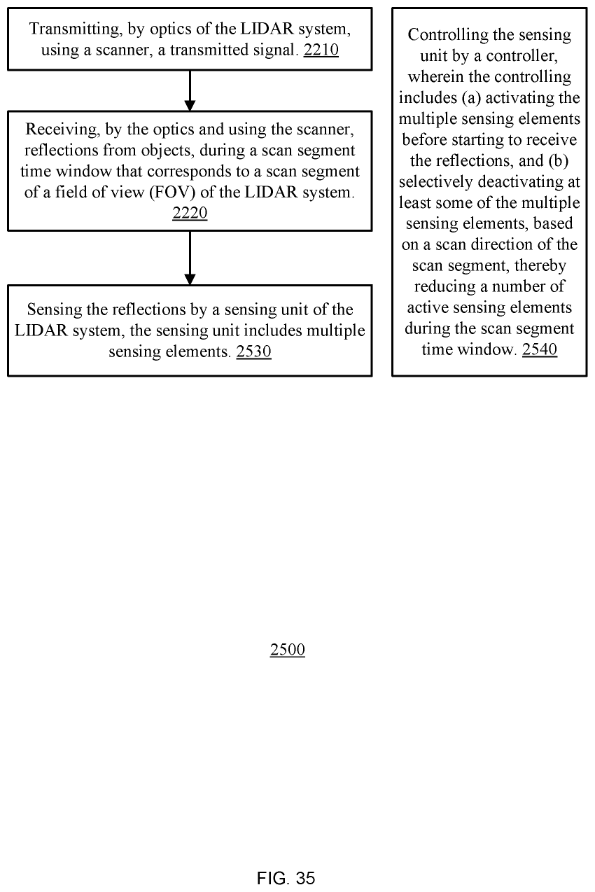

FIG. 35 is an example of a method; and

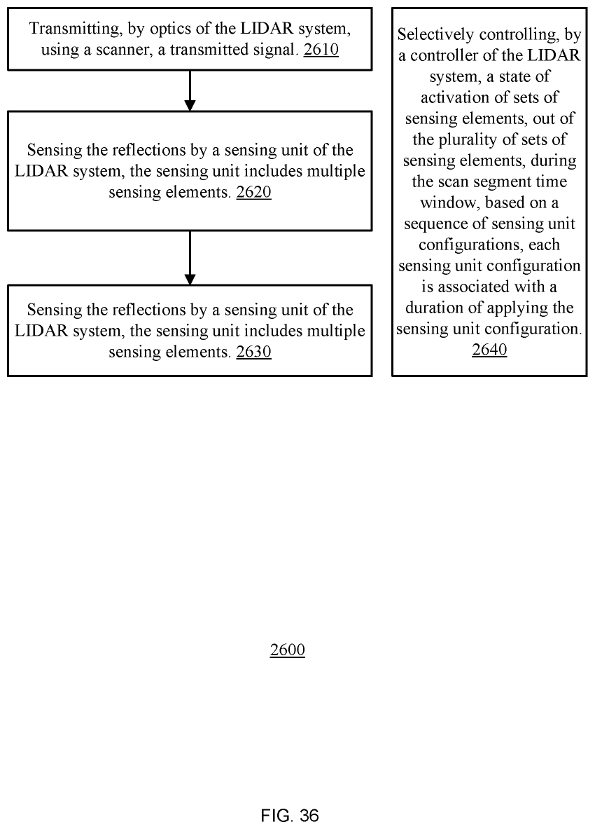

FIG. 36 is an example of a method.

### DETAILED DESCRIPTION

The accompanying drawings, which are incorporated in and constitute a part of this disclosure, illustrate various disclosed embodiments. The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Terms Definitions

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g. number of meters, number of inches, number of kilometers, number of millimeters), a number of arbitrary length units (e.g. number of LIDAR system lengths), a ratio between the distance to another length (e.g. a ratio to a length of an object detected in a field of view of the LIDAR system), an amount of time (e.g. given as standard unit, arbitrary units or ratio, for example, the time it takes light to travel between the tangible objects), one or more locations (e.g. specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g. by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g. location information (e.g. relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, +40°−20°, ±90°or 0°-90°).

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of the LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g. defined using φ, θ angles, in which φ and θ are angles defined in perpendicular planes, e.g. with respect to symmetry axes of the LIDAR system and/or its FOV). In one example, the field of view may also be defined within a certain range (e.g. up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, a LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g. earth, roads, grass, sidewalks, road surface marking), sky, man-made objects (e.g. vehicles, buildings, signs), vegetation, people, animals, light projecting elements (e.g. flashlights, sun, other LIDAR systems), and so on.

Any reference to the term “actuator” should be applied mutatis mutandis to the term “manipulator”. Non-limiting examples of manipulators include Micro-Electro-Mechanical Systems (MEMS) actuators, Voice Coil Magnets, motors, piezoelectric elements, and the like. It should be noted that a manipulator may be merged with a temperature control unit.

Disclosed embodiments may involve obtaining information for use in generating reconstructed three-dimensional models. Examples of types of reconstructed three-dimensional models which may be used include point cloud models, and Polygon Mesh (e.g. a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g. 1 cm3), and whose location may be described by the point cloud model using a set of coordinates (e.g. (X,Y,Z), (r,φ,θ)). By way of example only, the point cloud model may store additional information for some or all of its points (e.g. color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2 and 3 of the current application and with reference to FIGS. 2A-2C of PCT patent application PCT/IB2020/055283 publication number WO2020/245767 which is incorporated herein by reference.

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g. controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g. a mirror), at least one refracting element (e.g. a prism, a lens), and so on. In one example, the light deflector may be movable, to cause light deviate to differing degrees (e.g. discrete degrees, or over a continuous span of degrees). The light deflector may optionally be controllable in different ways (e.g. deflect to a degree a, change deflection angle by Aa, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and φ coordinates). Alternatively or in addition, the light deflector may optionally be operable to change an angle of deflection between predetermined settings (e.g. along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3C of PCT patent application PCT/IB2020/055283 publication number WO2020/245767 which is incorporated herein by reference.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS mirror implementations, the MEMS mirror may move by actuation of a plurality of benders connected to the mirror, the mirror may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g. non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g. mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g. atmospheric temperature, rain, etc.).

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns. Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4 and 5 of the current application and with reference to FIGS. 4A-4C of PCT patent application PCT/IB2020/055283 publication number WO2020/245767 which is incorporated herein by reference.

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIG. 6 of the current application and with reference to FIGS. 5A-5C of PCT patent application PCT/IB2020/055283 publication number WO2020/245767 which is incorporated herein by reference.

FIG. 1 illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, at least one processor 118 may be configured to coordinate operation of the at least one light source 112 with the movement of at least one light deflector 114 in order to scan a field of view 120. During a scanning cycle, each instantaneous position of at least one light deflector 114 may be associated with a particular portion 122 of field of view 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

Consistent with the present disclosure, LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and water craft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into a bumper, a fender, a side panel, a spoiler, a roof, a headlight assembly, a taillight assembly, a rear-view mirror assembly, a hood, a trunk or any other suitable part of vehicle 110 capable of housing at least a portion of the LIDAR system. In some cases, LIDAR system 100 may capture a complete surround view of the environment of vehicle 110. Thus, LIDAR system 100 may have a 360-degree horizontal field of view. In one example, as shown in FIG. 1, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with an 80° to 120° field of view or less, depending on the number of units employed. Moreover, a 360-degree horizontal field of view may be also obtained by mounting a multiple LIDAR systems 100 on vehicle 110, each with a single scanning unit 104. It is nevertheless noted that the one or more LIDAR systems 100 do not have to provide a complete 360° field of view, and that narrower fields of view may be useful in some situations. For example, vehicle 110 may require a first LIDAR system 100 having a field of view of 75° looking ahead of the vehicle, and possibly a second LIDAR system 100 with a similar FOV looking backward (optionally with a lower detection range). It is also noted that different vertical field of view angles may also be implemented.

### The Projecting Unit

FIGS. 2 and 3 depict various configurations of projecting unit 102 and its role in LIDAR system 100. Specifically, FIG. 2 is a diagram illustrating projecting unit 102 with a single light source; FIG. 3 is a diagram illustrating a plurality of projecting units 102 with a plurality of light sources aimed at a common light deflector 114. One skilled in the art will appreciate that the depicted configurations of projecting unit 102 may have numerous variations and modifications. Non limiting examples are provided in FIGS. 2C-2G of PCT patent application PCT/IB2020/055283 publication number WO2020/245767 which is incorporated herein by reference

FIG. 2 illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources).

In this embodiment, all the components of LIDAR system 100 may be contained within a single housing 200, or may be divided among a plurality of housings. As shown, projecting unit 102 is associated with a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g. for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108.

In this figure, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g. a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g. cameras, microphones, radar systems). In one example, LIDAR system 100 may be used by a security system.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. As discussed below in greater detail, in some situations LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated services digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 3 illustrates an example of a monostatic configuration of LIDAR system 100 including a plurality projecting units 102. The term “monostatic configuration” broadly refers to LIDAR system configurations in which the projected light exiting from the LIDAR system and the reflected light entering the LIDAR system pass through substantially similar optical paths. In one example, the outbound light beam and the inbound light beam may share at least one optical assembly through which both outbound and inbound light beams pass. In another example, the outbound light may pass through an optical window (not shown) and the inbound light radiation may pass through the same optical window. A monostatic configuration may include a configuration where the scanning unit 104 includes a single light deflector 114 that directs the projected light towards field of view 120 and directs the reflected light towards a sensor 116. As shown, both projected light 204 and reflected light 206 hits an asymmetrical deflector 216. The term “asymmetrical deflector” refers to any optical device having two sides capable of deflecting a beam of light hitting it from one side in a different direction than it deflects a beam of light hitting it from the second side. In one example, the asymmetrical deflector does not deflect projected light 204 and deflects reflected light 206 towards sensor 116. One example of an asymmetrical deflector may include a polarization beam splitter. In another example, asymmetrical 216 may include an optical isolator that allows the passage of light in only one direction. A diagrammatic representation of asymmetrical deflector 216 is illustrated in FIG. 2D. Consistent with the present disclosure, a monostatic configuration of LIDAR system 100 may include an asymmetrical deflector to prevent reflected light from hitting light source 112, and to direct all the reflected light toward sensor 116, thereby increasing detection sensitivity.

In the embodiment of FIG. 3, LIDAR system 100 includes three projecting units 102 each with a single of light source 112 aimed at a common light deflector 114. In one embodiment, the plurality of light sources 112 (including two or more light sources) may project light with substantially the same wavelength and each light source 112 is generally associated with a differing area of the field of view (denoted in the figure as 120A, 120B, and 120C). This enables scanning of a broader field of view than can be achieved with a light source 112. In another embodiment, the plurality of light sources 102 may project light with differing wavelengths, and all the light sources 112 may be directed to the same portion (or overlapping portions) of field of view 120.

### The Sensing Unit

FIGS. 5 and 6 depict various configurations of sensing unit 106 and its role in LIDAR system 100. Specifically, FIG. 5 is a diagram illustrating a lens array associated with sensor 116, and FIG. 6 includes three diagram illustrating the lens structure. One skilled in the art will appreciate that the depicted configurations of sensing unit 106 are exemplary only and may have numerous alternative variations and modifications consistent with the principles of this disclosure.

FIG. 4 is a cross cut diagram of a part of sensor 116, in accordance with examples of the presently disclosed subject matter. The illustrated part of sensor 116 includes a part of a detector array 400 which includes four detection elements 402 (e.g., four SPADs, four APDs). Detector array 400 may be a photodetector sensor realized in complementary metal-oxide semiconductor (CMOS). Each of the detection elements 402 has a sensitive area, which is positioned within a substrate surrounding. While not necessarily so, sensor 116 may be used in a monostatic LIDAR system having a narrow field of view (e.g., because scanning unit 104 scans different parts of the field of view at different times). The narrow field of view for the incoming light beam—if implemented—eliminates the problem of out-of-focus imaging. As exemplified in FIG. 4, sensor 116 may include a plurality of lenses 422 (e.g., microlenses), each lens 422 may direct incident light toward a different detection element 402 (e.g., toward an active area of detection element 402), which may be usable when out-of-focus imaging is not an issue. Lenses 422 may be used for increasing an optical fill factor and sensitivity of detector array 400, because most of the light that reaches sensor 116 may be deflected toward the active areas of detection elements 402

Detector array 400, as exemplified in FIG. 4, may include several layers built into the silicon substrate by various methods (e.g., implant) resulting in a sensitive area, contact elements to the metal layers and isolation elements (e.g., shallow trench implant STI, guard rings, optical trenches, etc.). The sensitive area may be a volumetric element in the CMOS detector that enables the optical conversion of incoming photons into a current flow given an adequate voltage bias is applied to the device. In the case of an APD/SPAD, the sensitive area would be a combination of an electrical field that pulls electrons created by photon absorption towards a multiplication area where a photon induced electron is amplified creating a breakdown avalanche of multiplied electrons.

A front side illuminated detector (e.g., as illustrated in FIG. 4) has the input optical port at the same side as the metal layers residing on top of the semiconductor (Silicon). The metal layers are required to realize the electrical connections of each individual photodetector element (e.g., anode and cathode) with various elements such as: bias voltage, quenching/ballast elements, and other photodetectors in a common array. The optical port through which the photons impinge upon the detector sensitive area is comprised of a passage through the metal layer. It is noted that passage of light from some directions through this passage may be blocked by one or more metal layers (e.g., metal layer ML6, as illustrated for the leftmost detector elements 402 in FIG. 4). Such blockage reduces the total optical light absorbing efficiency of the detector.

FIG. 5 illustrates three detection elements 402, each with an associated lens 422, in accordance with examples of the presenting disclosed subject matter. Each of the three detection elements of FIG. 5, denoted 402(1), 402(2), and 402(3), illustrates a lens configuration which may be implemented in associated with one or more of the detecting elements 402 of sensor 116. It is noted that combinations of these lens configurations may also be implemented.

In the lens configuration illustrated with regards to detection element 402(1), a focal point of the associated lens 422 may be located above the semiconductor surface. Optionally, openings in different metal layers of the detection element may have different sizes aligned with the cone of focusing light generated by the associated lens 422. Such a structure may improve the signal-to-noise and resolution of the array 400 as a whole device. Large metal layers may be important for delivery of power and ground shielding. This approach may be useful, e.g., with a monostatic LIDAR design with a narrow field of view where the incoming light beam is comprised of parallel rays and the imaging focus does not have any consequence to the detected signal.

In the lens configuration illustrated with regards to detection element 402(2), an efficiency of photon detection by the detection elements 402 may be improved by identifying a sweet spot. Specifically, a photodetector implemented in CMOS may have a sweet spot in the sensitive volume area where the probability of a photon creating an avalanche effect is the highest. Therefore, a focal point of lens 422 may be positioned inside the sensitive volume area at the sweet spot location, as demonstrated by detection elements 402(2). The lens shape and distance from the focal point may take into account the refractive indices of all the elements the laser beam is passing along the way from the lens to the sensitive sweet spot location buried in the semiconductor material.

In the lens configuration illustrated with regards to the detection element on the right of FIG. 5, an efficiency of photon absorption in the semiconductor material may be improved using a diffuser and reflective elements. Specifically, a near IR wavelength requires a significantly long path of silicon material in order to achieve a high probability of absorbing a photon that travels through. In a typical lens configuration, a photon may traverse the sensitive area and may not be absorbed into a detectable electron. A long absorption path that improves the probability for a photon to create an electron renders the size of the sensitive area towards less practical dimensions (tens of um for example) for a CMOS device fabricated with typical foundry processes. The rightmost detector element in FIG. 5 demonstrates a technique for processing incoming photons. The associated lens 422 focuses the incoming light onto a diffuser element 424. In one embodiment, light sensor 116 may further include a diffuser located in the gap distant from the outer surface of at least some of the detectors. For example, diffuser 424 may steer the light beam sideways (e.g., as perpendicular as possible) towards the sensitive area and the reflective optical trenches 426. The diffuser is located at the focal point, above the focal point, or below the focal point. In this embodiment, the incoming light may be focused on a specific location where a diffuser element is located. Optionally, detector element 422 is designed to optically avoid the inactive areas where a photon induced electron may get lost and reduce the effective detection efficiency. Reflective optical trenches 426 (or other forms of optically reflective structures) cause the photons to bounce back and forth across the sensitive area, thus increasing the likelihood of detection. Ideally, the photons will get trapped in a cavity consisting of the sensitive area and the reflective trenches indefinitely until the photon is absorbed and creates an electron/hole pair.

Consistent with the present disclosure, a long path is created for the impinging photons to be absorbed and contribute to a higher probability of detection. Optical trenches may also be implemented in detecting element 422 for reducing cross talk effects of parasitic photons created during an avalanche that may leak to other detectors and cause false detection events. According to some embodiments, a photo detector array may be optimized so that a higher yield of the received signal is utilized, meaning, that as much of the received signal is received and less of the signal is lost to internal degradation of the signal. The photo detector array may be improved by: (a) moving the focal point at a location above the semiconductor surface, optionally by designing the metal layers above the substrate appropriately; (b) by steering the focal point to the most responsive/sensitive area (or “sweet spot”) of the substrate and (c) adding a diffuser above the substrate to steer the signal toward the “sweet spot” and/or adding reflective material to the trenches so that deflected signals are reflected back to the “sweet spot.”

While in some lens configurations, lens 422 may be positioned so that its focal point is above a center of the corresponding detection element 402, it is noted that this is not necessarily so. In other lens configuration, a position of the focal point of the lens 422 with respect to a center of the corresponding detection element 402 is shifted based on a distance of the respective detection element 402 from a center of the detection array 400. This may be useful in relatively larger detection arrays 400, in which detector elements further from the center receive light in angles which are increasingly off-axis. Shifting the location of the focal points (e.g., toward the center of detection array 400) allows correcting for the incidence angles. Specifically, shifting the location of the focal points (e.g., toward the center of detection array 400) allows correcting for the incidence angles while using substantially identical lenses 422 for all detection elements, which are positioned at the same angle with respect to a surface of the detector.

Adding an array of lenses 422 to an array of detection elements 402 may be useful when using a relatively small sensor 116 which covers only a small part of the field of view because in such a case, the reflection signals from the scene reach the detectors array 400 from substantially the same angle, and it is, therefore, easy to focus all the light onto individual detectors. It is also noted, that in one embodiment, lenses 422 may be used in LIDAR system 100 for favoring about increasing the overall probability of detection of the entire array 400 (preventing photons from being “wasted” in the dead area between detectors/sub-detectors) at the expense of spatial distinctiveness. This embodiment is in contrast to prior art implementations such as CMOS RGB camera, which prioritize spatial distinctiveness (i.e., light that propagates in the direction of detection element A is not allowed to be directed by the lens toward detection element B, that is, to “bleed” to another detection element of the array). Optionally, sensor 116 includes an array of lens 422, each being correlated to a corresponding detection element 402, while at least one of the lenses 422 deflects light which propagates to a first detection element 402 toward a second detection element 402 (thereby it may increase the overall probability of detection of the entire array).

Specifically, consistent with some embodiments of the present disclosure, light sensor 116 may include an array of light detectors (e.g., detector array 400), each light detector (e.g., detector 410) being configured to cause an electric current to flow when light passes through an outer surface of a respective detector. In addition, light sensor 116 may include at least one micro-lens configured to direct light toward the array of light detectors, the at least one micro-lens having a focal point. Light sensor 116 may further include at least one layer of conductive material interposed between the at least one micro-lens and the array of light detectors and having a gap therein to permit light to pass from the at least one micro-lens to the array, the at least one layer being sized to maintain a space between the at least one micro-lens and the array to cause the focal point (e.g., the focal point may be a plane) to be located in the gap, at a location spaced from the detecting surfaces of the array of light detectors.

In related embodiments, each detector may include a plurality of Single Photon Avalanche Diodes (SPADs) or a plurality of Avalanche Photo Diodes (APD). The conductive material may be a multi-layer metal constriction, and the at least one layer of conductive material may be electrically connected to detectors in the array. In one example, the at least one layer of conductive material includes a plurality of layers. In addition, the gap may be shaped to converge from the at least one micro-lens toward the focal point, and to diverge from a region of the focal point toward the array. In other embodiments, light sensor 116 may further include at least one reflector adjacent each photo detector. In one embodiment, a plurality of micro-lenses may be arranged in a lens array and the plurality of detectors may be arranged in a detector array. In another embodiment, the plurality of micro-lenses may include a single lens configured to project light to a plurality of detectors in the array.

### The Processing Unit

FIG. 6 illustrates four examples of emission patterns in a single frame-time for a single portion 122 of field of view 120 associated with an instantaneous position of at least one light deflector 114. Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 6 depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the initial light emission. In one embodiment, the pilot information may be represented as a single signal based on the outputs of one or more detectors (e.g. one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g. for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame).

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g. 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following.
a. Overall energy of the subsequent emission.
b. Energy profile of the subsequent emission.
c. A number of light-pulse-repetition per frame.
d. Light modulation characteristics such as duration, rate, peak, average power, and pulse shape.
e. Wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g. regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

It should be noted that while examples of various disclosed embodiments have been described above and below with respect to a control unit that controls scanning of a deflector, the various features of the disclosed embodiments are not limited to such systems. Rather, the techniques for allocating light to various portions of a LIDAR FOV may be applicable to type of light-based sensing system (LIDAR or otherwise) in which there may be a desire or need to direct different amounts of light to different portions of field of view. In some cases, such light allocation techniques may positively impact detection capabilities, as described herein, but other advantages may also result.

It should also be noted that various sections of the disclosure and the claims may refer to various components or portions of components (e.g., light sources, sensors, sensor pixels, field of view portions, field of view pixels, etc.) using such terms as “first,” “second,” “third,” etc. These terms are used only to facilitate the description of the various disclosed embodiments and are not intended to be limiting or to indicate any necessary correlation with similarly named elements or components in other embodiments.

For example, characteristics described as associated with a “first sensor” in one described embodiment in one section of the disclosure may or may not be associated with a “first sensor” of a different embodiment described in a different section of the disclosure. It should noted that LIDAR system 100, or any of its components, may be used together with any of the particular embodiments and methods disclosed below. Nevertheless, the particular embodiments and methods disclosed below are not necessarily limited to LIDAR system 100, and may possibly be implemented in or by other systems (such as but not limited to other LIDAR systems, other electrooptical systems, other optical systems, etc.—whichever is applicable). Also, while system 100 is described relative to an exemplary vehicle-based LIDAR platform, system 100, any of its components, and any of the processes described herein may be applicable to LIDAR systems disposed on other platform types. Likewise, the embodiments and processes disclosed below may be implemented on or by LIDAR systems (or other systems such as other elecrooptical systems etc.) which are installed on systems disposed on platforms other than vehicles, or even regardless of any specific platform.

FIG. 7 illustrates an exemplary LIDAR system 100 including beam splitter 1110. As illustrated in FIG. 7, LIDAR system 100 may include monolithic laser array 950 configured to emit one or more beams of laser light (e.g., 1102, 1104, 1106, 1108). The one or more beams of laser light may be collimated by one or more collimators 1112 before beams 1102, 1104, 1106, and/or 1108 are incident on beam splitter 1110. Beam splitter 1110 may allow laser light beams 1102, 1104, 1106, and/or 1108 to pass through and be incident on deflectors 1121, 1123, which may be configured to direct laser light beams 1102, 1104, 1106, and/or 1108 towards FOV 1170. Although only two deflectors 1121, 1123 have been illustrated in FIG. 7, it is contemplated that LIDAR system 100 may include more than two deflectors 1121, 1123 configured to direct one or more of the light beams 1102, 1104, 1106, and/or 1108 towards FOV 1170.

One or more objects in FOV 170 may reflect one or more of the light beams 1102, 1104, 1106, and/or 1108. As illustrated in FIG. 7, the reflected light beams may be represented as laser light beams 1152, 1154, 1156, and/or 1158. Although reflected laser light beams 1152, 1154, 1156, and/or 1158 are illustrated in FIG. 7 as being directly incident on beam splitter 1110, it is contemplated that some or all of light beams 1152, 1154, 1156, and/or 1158 may be directed by deflectors 1121, 1123 and/or another deflector towards beam splitter 1110. When light beams 1152, 1154, 1156, and/or 1158 reach splitter 1110, splitter 1110 may be configured to direct reflected light beams 1152, 1154, 1156, and/or 1158 received from FOV 1170 towards detector 1130 via lens 1122. Although FIG. 7 illustrates four light beams being emitted by monolithic laser array 950, it is contemplated that monolithic laser array 950 may emit any number of light beams (e.g., less than or more than four).

In some embodiments, the beam splitter is configured to re-direct each of the plurality of laser beams and pass a plurality of reflected beams received from the field of view of the LIDAR system. By way of example, FIG. 8 illustrates an exemplary LIDAR system 100 that may include monolithic laser array 950, collimator 1112, beam splitter 1110, deflector 1121, 1123, lens and /r optical filter 1122 and detector 1130. A monolithic laser array 950 may emit one or more laser light beams 1102, 1104, 1106, and/or 1108 that may be collimated by one or more collimators 1112 before being incident on beam splitter 1110.

Beam splitter 1110 may be configured to direct one or more of the laser light beams 1102, 1104, 1106, and/or 1108 towards deflectors 1121, 1123, which in turn may be configured to direct the one or more laser light beams 1102, 1104, 1106, and/or 1108 towards FOV 1170. One or more objects in FOV 1170 may reflect one or more of the laser light beams 1102, 1104, 1106, and/or 1108. Reflected laser light beams 1152, 1154, 1156, and/or 1158 may be directed by deflectors 1121, 1123 to be incident on beam splitter 1110. It is also contemplated that some or all of reflected laser light beams 1152, 1154, 1156, and/or 1158 may reach beam splitter 1110 without being directed by deflector 1121, 1123 towards beam splitter 1110.

As illustrated in FIG. 8 beam splitter 1110 may be configured to allow the reflected laser light beams 1152, 1154, 1156, and/or 1158 to pass through beam splitter 1110 towards detector 1130. One or more lenses and/or optical filters 1122 may receive the reflected laser light beams 1152, 1154, 1156, and/or 1158 and direct these light beams towards detector 1130. Although FIG. 8 illustrates four light beams being admitted by monolithic laser array 950, it is contemplated that monolithic laser array 950 may emit any number of light beams (e.g., less than or more than four).

A sensing element circuit may include only a sensing element but may also include (in addition to the sensing element) additional circuitry such as electrical components such as resistors and/or capacitors and/or inductors that may be used for various purposes such as biasing the sensing element, discharging the sensing element, providing bias to the sensing element, setting a working point of the sensing element, charging the sensing element, and the like. The sensing element circuitry may include output signal selection unit for selecting an output port (out of multiple output ports) for outputting a detection signal indicative of radiation sensed by the sensing element.

A reception window is a group of sensing element circuits that may be two dimensional. The group of sensing elements circuits may be positioned to sense reflected light spots that impinge on the reception window.

A reception window may be read by a readout circuit while sensing element circuits (or at least a majority of sensing element circuits) outside any reception window may be ignored during the readout process.

### Adaptive Control of an Array of Sensing Element Circuits

According to an embodiment, there is provided a LIDAR system that includes (a) an array of sensing element circuits (SECs), the array comprises multiple sub-arrays of SECs, (b) a readout unit, (c) a coupling unit; and (d) a controller that is configured to select, of the multiple sub-arrays, a first sub-array and a second sub-array. The selection is based on expected locations of concurrently impinging reflections from objects illuminated by a transmitted signal that was transmitted by the LIDAR system. The second sub-array is horizontally and vertically shifted from the first sub-array. Examples of parts of LIDAR systems are illustrated in FIGS. 11-14.

The first sub-array and the second sub-array are configured to generate detection signals indicative of the reflections.

The coupling unit is configured to couple the readout unit to the first sub array and the second sub-array.

The readout unit is configured to read one or more readout unit input signals that are indicative of the detection signals.

According to an embodiment, the selection is also based on one or more LIDAR system misalignments. The LIDAR system misalignments may result in having different reflections that concurrently impinge on locations of the sensing unit that are horizontally shifted from each other and the selection compensates for this horizontal shift.

According to an embodiment, the controller is also configured to deactivate at least one additional sub-array of the array.

According to an embodiment, the coupling unit comprises horizontal shifting elements that are configured to couple the first sub array and the second sub-array.

According to an embodiment, LIDAR system further includes power supply shifting elements that are configured to couple a first sub array power supply conduit to a second sub array power supply conduit.

According to an embodiment, the horizontal shifting elements are further configured to couple the first sub array to a third sub-array, the third sub-array is horizontally and vertically shifted from the first sub array and is at least horizontally shifted from the second sub-array. See, for example FIG. 13.

According to an embodiment, the LIDAR system further includes a power supply unit that is configured to supply power to the first sub-array and the second sub-array while preventing from supplying power to at least one additional sub-array of the array of SECs.

According to an embodiment, the SEC comprises multiple outputs for outputting a detection signal generated by the SEC.

FIG. 30 illustrates an example of method 2000.

According to an embodiment, method 2000 includes step 2010 of receiving a selection, out of multiple sub-arrays of sensing element circuits (SECs) of an array of SECs of sensing unit, of a first sub-array and a second sub-array, the selection is based on expected locations of concurrently impinging reflections from objects illuminated by a transmitted signal that was transmitted by the LIDAR system, wherein the second sub-array is horizontally and vertically shifted from the first sub-array.

According to an embodiment, step 2010 is followed by step 2020 of coupling, by a coupling unit, a readout unit to the first sub array and the second sub-array.

According to an embodiment, step 2020 is followed by step 2030 of generating detection signals, by the first sub-array and the second sub-array, the detection signals are indicative of the reflections. According to an embodiment, step 2030 is followed by step 2040 of generating detection signals, by the first sub-array and the second sub-array, the detection signals are indicative of the

reflections. According to an embodiment, step 2040 is followed by step 2050 of reading, by the

readout circuit, one or more readout unit input signals that are indicative of the detection signals. According to an embodiment, there is provided a non-transitory computer medium that stores instructions for: receiving a selection, out of multiple sub-arrays of sensing element circuits (SECs) of an array of SECs of sensing unit, of a first sub-array and a second sub-array, the selection is based on expected locations of concurrently impinging reflections from objects illuminated by a transmitted signal that was transmitted by the LIDAR system, wherein the second sub-array is horizontally and vertically shifted from the first sub-array; coupling, by a coupling unit, a readout unit to the first sub array and the second sub-array; generating detection signals, by the first sub-array and the second sub-array, the detection signals are indicative of the reflections; and reading, by the readout circuit, one or more readout unit input signals that are indicative of the detection signals.

FIG. 9 illustrates a sensing element circuits array (“array”) 604 that includes an array of sensing element circuits 608 that are arranged in rows and columns.

FIG. 9 also illustrates horizontally aligned reception windows 610(1)-610(5) that fall on different rows of the array.

The reception windows may correspond to an instantaneous FOV and may follow the shape of one or more reflected light spots that impinge on the array simultaneously.

Due to the horizontal alignment of the different reception windows, there is a need to read only a limited number of relevant columns—the columns that fall on the reception windows for example relevant columns 607(1)-607(7).

During a readout, the sensing element circuits of the relevant columns are powered (receive power from power supply 601 through supply lines 602 that are connected via supply line switches 603). The sensing element circuits of the relevant columns are read by a readout switch matrix 605—whereas the reading may include reading the output signal of each sensing element circuit, adding the signals of multiple sensing elements circuits, averaging the signals of the sensing element circuits, and the like.

The adding and/or averaging may be executed by the readout switch matrix 605 and/or the sense amplifiers 606 and/or may be executed after the sense amplifiers 606 output their output signals—in the analog and/or digital domain.

Due to various reasons—including LIDAR system misalignments, the different reception windows may be horizontally misaligned—as illustrated in FIG. 10 (see horizontally misaligned reception windows 610(1)-610(5)). This may require reading out from a larger number of columns (in comparison to the scenario of FIG. 9—see relevant columns 607(1)-607(11) of FIG. 10) and also requires reading much more irrelevant sensing element circuits 613 (located outside the different reception windows but within the relevant columns)—which may reduce the signal to noise ratio of the individual detection signals.

The evaluation of the position of the reception windows—especially their horizontal misalignment may be triggered by any event (the event may be a sensed event and/or an estimated event) and/or may be executed in any frequency—one or more time in a lifetime, during each period (one or more hours, one or more days, one or more weeks, one or more months, one or more years, and the like). The evaluation may be executed before shipment of the LIDAR from its manufacturer, after the LIDAR is shipped from its manufacturer—for example during operation of the LIDAR, and may be updated dynamically in operation.

In order to reduce the noise introduced by reading irrelevant sensing element circuits and to reduce the number of relevant columns to be read—the array is segmented to sub-arrays (and the columns are segmented to sub-columns).

The sub-arrays are separated by (and connected by) horizontal shifting units such as horizontal shifting element sets—that define virtual relevant columns. The virtual relevant columns include relevant sub-columns that may cover the different reception windows in a more effective manner. A virtual relevant column may include relevant sub-columns wherein for each sub-array that include a reception window—the sub-column of that sub-array is covered by the reception window.

FIG. 11 illustrates an example of an array 604 that is segmented to nine sub-arrays 609(1)-609(9) by eight horizontal shifting sets 612(1)-612(8).

FIG. 11 also illustrates virtual columns 613(1) and 613(3). There are more virtual columns that are not shown—for simplicity of explanation.

It should be noted that while FIG. 11 illustrates one output port (and one readout line) per row of sensing element circuits—FIG. 12 illustrates two output row lines per row of sensing element circuits (see additional row lines 615). These additional output row lines may be used for determining a horizontal misalignment related to of an object illuminated by the LIDAR—especially by selectively passing first detection signals of first sensing element circuits over a first row and selectively passing second detection signals of second sensing element circuits over a second row. This may involve allocating the first and second sensing element circuits in an alternating manner. A sum of the first sensing signals may be compared to the sum of the second sensing signals to find misalignments. While this examine referred to first and second rows—it is applicable to more than two rows—and requires sensing elements having more than two outputs.

FIG. 13 illustrates an example of nine sensing element circuits arranged in three rows and three columns, three power supply horizontal shifting elements 612(1,1), 612(1,2) and 612(1,3), and three output selection lines horizontal shifting elements 616(1,1), 616(1,2) and 616(1,3) respectively.

A sensing element circuit is illustrated as including a sensing element 608(1), additional components 608(3) such as resistor and capacitor, and output switch 608(2) for selecting whether the detection signals outputted from the sensing element circuit should be outputted from a first port of the sensing element circuit to row output line A (denoted SPAD out BL-A) or from a second port of the sensing element circuit to row output line B (denoted SPAD out BL-B). BL represents a bit line. There may be more than two rows and the sensing element circuits may include more than two outputs.

The power supply should be provided to a relevant virtual column. The power supply horizontal shifting elements virtually connect the sub-columns of the relevant virtual column by supplying the supply power to the relevant sensing element circuits.

The output signals should be outputted from a relevant virtual column. The output selection lines horizontal shifting elements provide the outputs from the sub-columns of the virtual column.

The horizontal shifting elements may be evenly spaced apart from each other, may be unevenly spaced from each other, may be spaced by any number of rows from each other, and there may be any number of horizontal shifting elements per array.

In FIG. 13 two upper sensing element circuits of each of the three rows are virtually connected to a lower sensing element circuits of a left shifted sub-column. A part of the virtual column is illustrated by dashed line 617.

It should be noted that a single sensing element circuit may output its output signal to a selected port of more than two output ports (see FIG. 14) and that a horizontal shifting element may perform a selection between three or more sub-columns.

FIG. 14 illustrates:
a. A first sensing element circuit 608 of a first sub-array, which is fed by a power supply and an output control signal for selecting (using selector 610) one of three outputs of the first sensing element circuit.
b. Horizontal shifting elements 609 for each one of the power supply and the output control signal. The horizontal shifting elements 609 are configured to selectively feed one of the sensing element circuit 608 of the second sub-array—according to the definition of a virtual column.

FIG. 15 illustrates the relationship between a distance of an object from the LIDAR (represented by polygon 801), a rotation of the polygon 801, and the horizontal location of the reflected light spots from an object within a reception window.

The polygon 801 scans the environment by rotating about an axis—for example by performing a clockwise rotation.

Scenes 701, 702, 703 and 704 illustrate reflections from objects located at increasing distances (D1, D2, D3 and D4) from the LIDAR, and the different positions of the polygon—which dictate a different location of the reflected spot (from the object) on the reception window 802. The clockwise rotation causes objects that are more distant from the LIDAR to be located towards the right side of the reception window. More distant objects appear smaller on the reception window and their reflections are attenuated due to the increasing distance.

It may be desirable that one or more reflected light spots from objects located within a certain distance will be centered about a certain horizontal coordinate within a reception window. This may guarantee that reflected light spots from objects located within a distance range of interest (for example between 100 and 200 meters) will fall within the reception window—which may be especially important for objects located within the upper end (i.e. the more distance end) of the distance range of interest—as the intensity of the reflected light spots decrease by a power of two of the distance d, i.e. as a function proportional to 1/d².

FIG. 16 illustrates an example of an aligned scene 705 in which a reflected light spots from an object located at distance D3 is centered about an alignment line 803 within reception window 802.

FIG. 16 also illustrates an example of a misaligned scene 706 in which reflected light spots from an object located at distance D3 are misaligned with alignment line 803 within reception window 802.

FIG. 17 illustrates sensing elements circuit of two sides—(i) side A sensing element circuits that output their signals via row output line A and are located to the left of the desired center, and (ii) side B sensing element circuits that output their signals via row output line B and are located to the right of the desired center.

The upper part of FIG. 17 illustrates the aligned scene 705 in which the number of illuminated side A sensing element circuits 721 equals the number of the illuminated side B sensing element circuits 722. Assuming a similar strength of detection signals per sensing element circuit and a summation of the detection signal per side—the aggregate detection signal from side A will substantially equal the aggregate detection signal from side B.

The lower part of FIG. 17 illustrates the misaligned scene 706 in which the number of illuminated side A sensing element circuits 721 differs the number of the illuminated side B sensing element circuits 722. In this case the reflected light spots are mostly to the left of the desired alignment. Assuming a similar strength of detection signals per sensing element circuit and a summation of the detection signal per side—the aggregate detection signal from side A will substantially exceed the aggregate detection signal from side B.

An alignment process may be provided and may include reading separate sensing element circuits via different row output lines of the same row.

The alignment evaluation may be executed at any frequency and/or may be triggered by any event. The event may be a sensed event and/or an estimated event.

An event may include a start of operation of the LIDAR system, any point in time during the operation of the LIDAR system, any change in a state of the LIDAR system or part of the LIDAR system (for example temperature change), any ambient condition change (rain, temperature, wind), any vehicle change (stop, acceleration, speed, and the like).

The alignment evaluation may be executed before shipment of the LIDAR system, after shipment of the LIDAR system from its manufacture, during operation of the LIDAR system, and the like.

### Reduced Reception Window

A LIDAR system may be configured to receive reflected light spots from objects over a wide distance range (for example between zero and 300 meters (or even more) from the LIDAR system).

The reflected light spots from objects that are very close to the LIDAR (for example between zero and a few tens of meters—for example between zero and fifty meters) are very strong and may saturate sensing elements (which then recover during a time consuming recovery process during which they are ineffective), in addition—the reflected light spots from close objects are relatively large and are detected by many radiation sensing elements.

Reflected light spots from very distant objects that are received after a rotating element (for example a polygon) of the LIDAR system may appear in a next frame as a ghost signal—and should be ignored.

It may be beneficial to define a reduced reception windows that will detect only a part of the reflected light spots from close objects and fully detect reflected light spots from objects located within a distance range of interest (for example between 100 and 200 meters).

The partially detected reflected light spots from close objects are large enough to enable efficient detection of the close objects even based on a part of the partially detected reflected light spots. The partial detection may reduce saturation.

The reduced reception window may partially detect reflected light spots from objects located after the distance range of interest and/or reject ghost signals. These reflected light spots are very weak and of low interest and may be only partially detected.

FIG. 18 illustrates the detection window 830 of a light sensor for partially detecting reflected light spots 831 from close objects, fully detecting reflected light spots 832 from objects located within a distance range of interest, partially detecting reflected light spots 833 from objects outside the distance range of interest and ignoring ghost signals 835.

FIG. 31 illustrates a LIDAR system 2100 that includes optics 2102, sensing unit 2104, controller 2106 and a local memory 2108.

According to an embodiment, the local memory is in the controller. According to an embodiment, the local memory is in the sensing unit. According to an embodiment, the local memory is in the controller and in the sensing unit.

According to an embodiment, “In the” means integrated with and/or a part of the same integrated circuit.

According to an embodiment the controller includes a local memory integrated in controller chip (IC), where the binary vector is stored.

According to an embodiment, the controller communicates the binary vector to the sensing unit.

According to an embodiment, the sensing unit has second local memory integrated in sensing unit integrated circuit.

According to an embodiment, stored on sensing unit local memory are the pixel configurations and/or SUCs configuration, and/or the sequence of SUCs.

According to an embodiment, a local memory in sensing unit saves time, and enables the speed required for the TOF tracking on a sub-pixel scale.

According to an embodiment, the controller has local memory integrated in a controller integrated circuit, where the binary vector is stored, along with SUC configurations and/or the sequences of SUC configurations.

According to an embodiment, the controller communicates the information stored in controller local memory to the sensing unit.

According to an embodiment, the configuration information is represented other than by the mentioned above binary vector.

The optics 2102 includes a scanner 2103. Examples of various components such as the optics, the sensing unit, and the controller are illustrated in FIGS. 1-5 and 7-8. It should be noted that LIDAR system 2100 may differ from the LIDAR systems illustrated in FIGS. 1-5 and 7-8. For example, the controller may be programmed in a different manner. Yet in another example—the optics may be modified and/or the sensing unit may be activated and/or operated in another manner.

According to an embodiment, optics 2102 is configured to (a) transmit, using a scanner, a transmitted signal, and (b) receive, using the scanner, reflections from objects, during a scan segment time window that corresponds to a scan segment of a field of view (FOV) of the LIDAR system.

According to an embodiment, sensing unit 2104 is configured to selectively sense the reflections by:
a. Avoiding sensing at least a part of a first reflection, the first reflection is from an object located within one or more first distance ranges from the LIDAR system. See, for example FIG. 18—the partially detecting reflected light spots 831 from close objects, and the partially detecting reflected light spots 833 from objects outside the distance range of interest.
b. Sensing an entirety of a second reflection, the second reflection is from an object located within one or more second distance ranges from the LIDAR system. See, for example, FIG. 18—fully detecting reflected light spots 832 from objects located within a distance range of interest.

According to an embodiment, controller 2106 is configured to maintain sensing elements expected to receive the second reflection active, and to maintain sensing elements expected to receive the at least part of the first reflection inactive.

According to an embodiment, the one or more first distance ranges comprise a short distance range related to reflections from objects associated with a distance from the LIDAR system that does not exceed a first distance threshold. See, for example FIG. 18—the partially detecting reflected light spots 831 from close objects.

According to an embodiment, the first distance threshold ranges between one and fifteen meters. According to an embodiment, the sensing unit is configured to sense only another part of each of the reflections related to the short distance range. See, for example FIG. 18—the partially detecting reflected light spots 831 from close objects, and the partially detecting reflected light spots 833 from objects outside the distance range of interest.

According to an embodiment, the sensing unit avoids sensing an entirety of a ghost reflection associated with another transmitted signal that was transmitted during a previous scan segment time window. See, for example FIG. 18—ignoring ghost signals 835. According to an embodiment, the controller is configured to define a reduced reception window that spans along only a part of the sensing unit. This definition results in not activating sensing circuits outside the reduced reception window.

According to an embodiment, the one or more first distance ranges comprise a long distance range related to reflections from objects associated with a distance from the LIDAR system that exceeds a second distance threshold. See, for example FIG. 18—the partially detecting reflected light spots 833 from objects outside the distance range of interest.

FIG. 32 is an example of method 2200 for operating a LIDAR system.

According to an embodiment, method 2200 includes step 2210 of transmitting, by optics of the LIDAR system, using a scanner, a transmitted signal.

According to an embodiment, step 2210 is followed by step 2220 of receiving, by the optics and using the scanner, reflections from objects, during a scan segment time window that corresponds to a scan segment of a field of view (FOV) of the LIDAR system.

According to an embodiment, step 2220 is followed by step 2230 of selectively sensing the reflections, by a sensing unit of the LIDAR, wherein the selectively sensing includes (i) avoiding from sensing at least a part of a first reflection, the first reflection is from an object located within one or more first distance ranges from the LIDAR system; and (ii) sensing an entirety of a second reflection, the second reflection is from an object located within one or more second distance ranges from the LIDAR system.

According to an embodiment, step 2230 includes:
a. Avoiding sensing at least a part of a first reflection, the first reflection is from an object located within one or more first distance ranges from the LIDAR system. See, for example FIG. 18—the partially detecting reflected light spots 831 from close objects, and the partially detecting reflected light spots 833 from objects outside the distance range of interest.
b. Sensing an entirety of a second reflection, the second reflection is from an object located within one or more second distance ranges from the LIDAR system. See, for example, FIG. 18—fully detecting reflected light spots 832 from objects located within a distance range of interest.

According to an embodiment, step 2230 includes maintaining sensing elements expected to receive the second reflection active, and to maintain sensing elements expected to receive the at least part of the first reflection inactive.

According to an embodiment, the one or more first distance ranges include a short distance range related to reflections from objects associated with a distance from the LIDAR system that does not exceed a first distance threshold. See, for example FIG. 18—the partially detecting reflected light spots 831 from close objects.

According to an embodiment, the first distance threshold ranges between one and fifteen meters. According to an embodiment, the sensing unit is configured to sense only another part of each of the reflections related to the short distance range. See, for example FIG. 18—the partially detecting reflected light spots 831 from close objects, and the partially detecting reflected light spots 833 from objects outside the distance range of interest.

According to an embodiment, step 2230 includes avoiding from sensing an entirety of a ghost reflection associated with another transmitted signal that was transmitted during a previous scan segment time window. See, for example FIG. 18—ignoring ghost signals 835.

According to an embodiment, step 2230 includes defining a reduced reception window that spans along only a part of the sensing unit. This is followed by not activating sensing circuits outside the reduced reception window.

According to an embodiment, the one or more first distance ranges include a long distance range related to reflections from objects associated with a distance from the LIDAR system that exceeds a second distance threshold. See, for example FIG. 18—the partially detecting reflected light spots 833 from objects outside the distance range of interest.

According to an embodiment, there is provided a non-transitory computer readable medium that stores instruction that once executed by a LIDAR system, causes the LIDAR system to: transmit, by optics of the LIDAR system, using a scanner, a transmitted signal; receive, by the optics and using the scanner, reflections from objects, during a scan segment time window that corresponds to a scan segment of a field of view (FOV) of the LIDAR system; and selectively sense the reflections, by a sensing unit of the LIDAR, wherein the selectively sensing comprises (i) avoiding from sensing at least a part of a first reflection, the first reflection is from an object located within one or more first distance ranges from the LIDAR system; and (ii) sensing an entirety of a second reflection, the second reflection is from an object located within one or more second distance ranges from the LIDAR system.

### Noise Reduction by Reducing Impact of Irrelevant Sensing Elements

When a scanning unit such as a polygon scans the FOV of the LIDAR system, the reception window may move according to the rotation of the polygon. The rotation of the polygon causes reflections from targets that are located at different distances from the LIDAR to impinge on the polygon at different points in time—while the polygon is at different angular positions—causing the reflections to move across the array of sensing elements—and changing the relevancy of sensing elements columns of a two-dimensional array of sensing elements.

FIG. 19 illustrates an array of sensing elements that includes group rows and group columns. FIG. 19 illustrates a first row of groups that include groups 1-1 till 1-8, a second row of groups that includes groups 2-1 till 2-8, seventh row of groups that include groups 7-1 till 7-8, and eighth row of groups that includes groups 8-1 till 8-8. The array is illustrates as including eight columns, each column may be independently receive a supply power (for example an anode voltage) or be disconnected from the supply power (for example—not be fed by an anode voltage). The power is supplied from a power supply and through independently controlled power supply switches 12-1 till 12-8.

The first row of groups is read (sensed) by first readout circuit Readout_1 10-1 in a row of group resolution. For example—the current read by first readout circuit Readout_1 10-1 is a sum of current from all sensing elements of groups 1-1 till 1-8. The resolution may be of a row of sub-group resolution.

This readout causes irrelevant sensing elements (sensing elements located outside the relevant sensing element relevant columns) to introduce noise.

The noise may be reduced by limiting the impact of irrelevant sensing elements on the readout signals.

The reduction may include, for example, disconnecting irrelevant sensing elements—and causing the irrelevant sensing elements to be discharged by impinging light (for example unwanted sun light) and reach inactive status (for example reach or pass a breakdown point) in which the irrelevant sensing elements do not generate any signal—or generate an insignificant signal.

The relevancy of the sensing elements is dictated by the expected location of light reflected as a result of light emission by the LIDAR system. The relevancy may be dictated, for example, by the rotation of the polygon—or any other scanning element.

Thus—once a relevant column becomes irrelevant—it may be disconnected from the power supply.

FIG. 19 illustrates the change, over time, of the relevancy of columns (a relevant column is denoted 525)—and how the power supply is provided. Symbol “+” marks a column that receives power supply. Symbol “−” marks a column that does not receive power supply. Symbol “D” marks a column that was just deactivated (such as column 526).

FIG. 20 illustrates an example of deactivating a column by switching the power supply (for example anode supply) from a first power supply 13-1 which provide enough power to keep the sensing elements active to a second power supply 13-2 which provide a low enough power supply to deactivate the sensing elements—for example—quickly bring a SPAD to its breakdown point. The switching may speed the disconnection and further reduce the noise.

FIG. 21 illustrates an array that includes unused rows before the first row of groups and after the eighth row of groups.

FIG. 21 also illustrates that the relevant columns include the next column on which the reflected light is expected to impinge.

FIG. 22 illustrates an example of different numbers of relevant columns.

It has been found that the instantaneous field of view (iFOV)size on the array of sensing elements is determined by the laser divergence, the time passing between illumination and receiving the light (time-of-flight) while the scanner is moving (subject of this disclosure) and mechanical tolerances.

Due to the TOF of the pulse and the polygon fast rotation, the iFOV is increased.

There may be provided a sensing element (for example a SiPM detector) vertical array. Where the horizontal size of the pixels is the horizontal iFOV in which the SiPM is divided to vertical columns that can be turned on and off separately. Then between illuminating the laser and receiving the light, during the TOF, the columns which are related to the short range are turned off so that the iFOV is decreased during the TOF. Further, the disabling of the columns could be done by disconnecting them (the anode) from the voltage source (there are other methods to do this, by connecting to ground or another electrical circuit)—The pixels in the column that are disconnected from high voltage will stay active for a short time until noise photons from ambient light or from dark noise will make the voltage drop below breakdown voltage. The concept is most advantageous in day light (when more ambient light reduces the SNR of the sensing element signal)

### Controlling a Sensing Unit

FIG. 33 illustrates an example of a LIDAR system 2300 that includes optics 2102, sensing unit 2104, controller 2106 and a local memory 2108. The optics 2102 includes a scanner 2103. Examples of various components such as the optics, the sensing unit, and the controller are illustrated in FIGS. 1-5 and 7-8. It should be noted that LIDAR system 2100 may differ from the LIDAR systems illustrated in FIGS. 1-5 and 7-8. For example, the controller may be programmed in a different manner. Yet for another example—the optics may be modified and/or the sensing unit may be activated and/or operated in another manner.

According to an embodiment, optics 2102 is configured to (a) transmit, using a scanner, a transmitted signal, and (b) receive, using the scanner, reflections from objects, during a scan segment time window that corresponds to a scan segment of a field of view (FOV) of the LIDAR system.

According to an embodiment, sensing unit 2104 includes multiple sensing elements 2305.

According to an embodiment, controller 2106 is arranged to (a) activate the multiple sensing elements before starting to receive the reflections, and (b) selectively deactivate at least some of the multiple sensing elements, based on a scan direction of the scan segment, thereby reducing a number of active sensing elements during the scan segment time window.

According to an embodiment, the multiple sensing elements includes a plurality of sets of sensing elements, wherein the controller is configured to selectively deactivate sets of sensing elements, out of the plurality of sets of sensing elements.

Examples of sets of sensing elements are illustrated in FIGS. 24-29—each group of boxes (each box being a group of sensing elements) that changes its status from activated to deactivated is a set of sensing elements.

According to an embodiment, each set of sensing elements is a line of groups of sensing elements. For example—sets of sensing elements that are arranged as a column are illustrated in FIGS. 24 and 28. See, for example in FIG. 24—the set of groups of sensing elements (each group of sensing elements being represented by a rectangle) includes the leftmost column of groups of sensing elements that was just deactivated—the leftmost column of groups of sensing elements at time T2, the second leftmost column of groups of sensing elements at time T3, the third leftmost column of groups of sensing elements at time T4, the second rightmost column of groups of sensing elements at time T6.

According to an embodiment, the each set of sensing elements includes a plurality of line of groups of sensing elements segments, wherein at least two of the plurality of line of groups of sensing elements segments are shifted from each other. For example—sets of sensing elements that are arranged as a virtual column that includes some groups of sensing elements that are both vertically and horizontally from each other are illustrated in FIGS. 25-27 .

According to an embodiment, the lateral shift between the at least two of the plurality of groups of sensing elements segments is selected for compensating for sensor unit misalignment. See, for example, FIGS. 26 and 27 in which the sets of sensing elements are defined according to horizontally misaligned reception windows 610(1)-610(5)—that may be misaligned due to sensor unit misalignments.

In order to reduce the communication bandwidth between the controller and its environment, and accordingly to reduce noises related to the communication of signals, and in order to ease and speed up the control of the sensing unit, there is provided a local memory 2108 that is configured to store a sequence of sensing unit configuration that control the sensing unit over time, during the scan segment time window—which is a relatively short window.

According to an embodiment, controller 2106 is configured to selectively deactivate the sets of the sensing elements based at least in part on a sequence of sensing unit configurations that are represented by configuration information 2120, each sensing unit configuration (SUC) is associated with a duration of applying the sensing unit configuration. Assuming that the sequence includes Q different SUCs—FIG. 33 illustrates that the configuration information includes configuration information about each one of the SUCs—denoted 2121(1)-212(Q), Q is an integer that exceeds one.

A non-limiting example of configuration information is provided below:

For simplicity of explanation it is assumed that each SUC configuration information defined a rectangle of sensing elements to be activated and that the rectangle is defined by two corners of the rectangle—for example:
SUC configuration 1 is defined by (upper left coordinate in a sensing element array X1-1, Y1-1) and (bottom right coordinate in a sensing element array X1-2, Y1-2).
SUC configuration 2 is defined by (upper left coordinate in a sensing element array X2-1, Y2-1) and (bottom right coordinate in a sensing element array X2-2, Y2-2).
Different SUC configurations define different points having different combinations of X and Y values.
In the example the sequence of SUCs includes (i) SUC configuration 1, (ii) SUC configuration 3 and (iii) SUC configuration 7.
The configuration information includes this list.
The configuration information includes each one of the relevant SUC configurations.
In the example the duration of the configurations differ from each other.
In the example, the duration information is represented by a binary vector (also a part of the configuration information) that has set bits to indicate when each configuration should be activated for example: [00100001000100 . . . ] . This indicates that (i) SUC configuration 1 should be applied from the third till the end of the seventh cycle, (ii) SUC configuration 5 should be applied from the eighth till the end of the eleventh cycle, and (iii) SUC configuration 7 should be applied from the twelfth cycle.
In this example each cycle is about 25 picoseconds long and can be generated by a time of flight clock.

According to an embodiment, the durations of applying all of the sensing unit configurations is the same.

According to an embodiment, a duration of applying one sensing unit configuration differs from a duration of applying another sensing unit configuration.

According to an embodiment, at least one sensing unit configuration is based on a fixed allocation of sensing elements per set of sensing elements. The fixed allocation does not change over time.

According to an embodiment, at least one sensing unit configuration is based on a dynamic allocation of sensing elements per set of sensing elements. This dynamic allocation changes over time and is adapted to changes in the operation of the LIDAR system—for example changes of a location of the reception window, and the like.

According to an embodiment, the dynamic allocation is responsive to misalignment related changes of locations of reflection.

According to an embodiment, the reducing of the number of active sensing elements is determined based on instantaneous signal to noise ratio (SNR) associated with the active sensing elements. For example—at a beginning of the scan segment time window the sensing unit received stronger reflections and more sensing elements are active while towards the end of the scan segment time window fewer sensing elements are active—as the reflections are weaker.

According to an embodiment, the transmitted signal is a single beam of light. See, for example the single reflection 901 received at a given point of time in FIG. 23.

According to an embodiment, the transmitted signal includes multiple beams of light. See, for example the multiple concurrently received reflections 901-1 till 901-4 received at a given point of time in FIGS. 24 and 25. The scan segment time window is relatively short—for example, assuming a relevant region of interest that spans up to 200 meters away from the vehicle—the duration of the scan segment time window is about 1.3 microseconds.

According to an embodiment, the FOV of the LIDAR system is scanned by multiple scan segments.

According to an embodiment, there are at least two scan segments of the multiple scan segments that exhibit a same scan direction.

According to an embodiment, there are at least two scan segments of the multiple scan segments that exhibit different scan directions. See, for example the LIDAR system FOV that is scanned by a raster scan pattern 2420 that has right-to-left scan lines, vertical lines (not shown) and left-to-right scan lines. Usually tens and even hundreds of transmissions (and hence tens end even hundreds of scan segment time window) occur during a single scan line.

According to an embodiment, the scanner is configured to output the transmitted signal, along a transmission optical axis, and to receive the reflections along one or more reception optical axes that are substantially parallel to the transmission optical axis.

According to an embodiment, for each reflection of the reflections, an angular difference between the transmission optical axis and a reception optical axis associated with the reflection does not exceed an angular difference associated with a scanner state difference between (a) a scanner state during a transmission of the transmitted single and (b) a scanner state during a reception of the reflection. Examples of scanner state differences are illustrated in FIGS. 15 and 16—note the different angles in which polygon 801 is located at different points in time.

FIG. 35 illustrates a method 3500 for operating a LIDAR system.

According to an embodiment, method 3500 includes step 2210 of transmitting, by optics of the LIDAR system, using a scanner, a transmitted signal.

According to an embodiment, step 2210 is followed by step 2220 of receiving, by the optics and using the scanner, reflections from objects, during a scan segment time window that corresponds to a scan segment of a field of view (FOV) of the LIDAR system.

According to an embodiment, step 2220 is followed by step 3530 of sensing the reflections by a sensing unit of the LIDAR system, the sensing unit includes multiple sensing elements.

According to an embodiment, method 3500 also include step 3540 of controlling the sensing unit by a controller, wherein the controlling includes (a) activating the multiple sensing elements before starting to receive the reflections, and (b) selectively deactivating at least some of the multiple sensing elements, based on a scan direction of the scan segment, thereby reducing a number of active sensing elements during the scan segment time window. The selective deactivation occurs during step 3530. Non-limiting examples of (a) and (b) are illustrated in FIGS. 23, 24 and 25.

According to an embodiment, controller 2106 is configured to selectively deactivate the sets of the sensing elements based at least in part on a sequence of sensing unit configurations that are represented by configuration information 2120, each sensing unit configuration is associated with a duration of applying the sensing unit configuration.

According to an embodiment, the durations of applying all of the sensing unit configurations is the same.

According to an embodiment, a duration of applying one sensing unit configuration differs from a duration of applying another sensing unit configuration.

According to an embodiment, at least one sensing unit configuration is based on a fixed allocation of sensing elements per set of sensing elements. The fixed allocation does not change over time.

According to an embodiment, at least one sensing unit configuration is based on a dynamic allocation of sensing elements per set of sensing elements. This dynamic allocation changes over time and is adapted to changes in the operation of the LIDAR system—for example changes of locations of reception windows, and the like.

According to an embodiment, the dynamic allocation is responsive to misalignment related changes of locations of reflection.

According to an embodiment, the reducing of the number of active sensing elements is determined based on instantaneous signal to noise ratio (SNR) associated with the active sensing elements. For example—at a beginning of the scan segment time window the sensing unit received stronger reflections and more sensing elements are active while towards the end of the scan segment time window fewer sensing elements are active—as the reflections are weaker.

According to an embodiment, the transmitted signal is a single beam of light. See, for example the single reflection 901 received at a given point of time in FIG. 23.

According to an embodiment, the transmitted signal includes multiple beams of light. See, for example the multiple concurrently received reflections 901-1 till 901-4 received at a given point of time in FIGS. 24 and 25.

According to an embodiment, the FOV of the LIDAR system is scanned by multiple scan segments.

According to an embodiment, there are at least two scan segments of the multiple scan segments that exhibit a same scan direction.

According to an embodiment, there are at least two scan segments of the multiple scan segments that exhibit different scan directions. See, for example the LIDAR system FOV that is scanned by a raster scan pattern 2420 that has right-to-left scan lines, vertical liner (not shown) and left-to-right scan lines.

According to an embodiment, method 3500 includes outputting the transmitted signal, along a transmission optical axis, and to receiving by the scanner the reflections along one or more reception optical axes that are substantially parallel to the transmission optical axis.

According to an embodiment, for each reflection of the reflections, an angular difference between the transmission optical axis and a reception optical axis associated with the reflection does not exceed an angular difference associated with a scanner state difference between (a) a scanner state during a transmission of the transmitted single and (b) a scanner state during a reception of the reflection. Examples of scanner state differences are illustrated in FIGS. 15 and 16—note the different angles in which polygon 801 is located at different points in time.

According to an embodiment, there is provided a non-transitory computer readable medium that stores instruction that once executed by a LIDAR system, causes the LIDAR system to: transmit, by optics of the LIDAR system, using a scanner, a transmitted signal; receive, by the optics and using the scanner, reflections from objects, during a scan segment time window that corresponds to a scan segment of a field of view (FOV) of the LIDAR system; sense the reflections by a sensing unit of the LIDAR system, the sensing unit includes multiple sensing elements; and control the sensing unit by a controller, wherein the controlling includes (a) activating the multiple sensing elements before starting to receive the reflections, and (b) selectively deactivating at least some of the multiple sensing elements, based on a scan direction of the scan segment, thereby reducing a number of active sensing elements during the scan segment time window

FIG. 36 illustrates a method 2600 for operating a LIDAR system.

According to an embodiment, method 2600 includes step 2610 of transmitting, by optics of the LIDAR system, using a scanner, a transmitted signal.

According to an embodiment, step 2610 is followed by step 2620 of receiving, by the optics and using the scanner, reflections from objects, during a scan segment time window that corresponds to a scan segment of a field of view (FOV) of the LIDAR system.

According to an embodiment, step 2620 is followed by step 2630 of sensing the reflections by a sensing unit of the LIDAR system, the sensing unit includes multiple sensing elements.

According to an embodiment, method 2600 includes step 2640 of selectively controlling, by a controller of the LIDAR system, a state of activation of sets of sensing elements, out of the plurality of sets of sensing elements, during the scan segment time window, based on a sequence of sensing unit configurations, each sensing unit configuration is associated with a duration of applying the sensing unit configuration.

According to an embodiment, step 2640 is executed (at least in part) in parallel to step 2630.

According to an embodiment, method 2600 includes storing in a local memory configuration information that defines the sequence of sensing unit configurations. See, for example configuration information 2120 of FIG. 33.

According to an embodiment, different sensing unit configurations are associated with a reception from objects located at different distance ranges from the LIDAR system.

According to an embodiment, the sensing unit configurations are determined based in part on the state of scanning differences between (a) a state of scanning during a time of transmission related to the transmitted signal, and (b) states of the scanning during reception times related to the reflections. For example—the location of sensing elements to be activated as responsive to the location of the reflections, and these locations take into account the scanning differences. See, for example, FIGS. 15 and 16.

According to an embodiment, a duration of applying one of the sensing unit configurations differs from a duration of applying another one of the sensing unit configurations.

According to an embodiment, a duration of applying one of the sensing unit configurations equals a duration of applying another one of the sensing unit configurations

According to an embodiment, controller 2106 of LIDAR system 2300 is configured to selectively control a state of activation of sets of sensing elements, out of the plurality of sets of sensing elements, during the scan segment time window, based on a sequence of sensing unit configurations, each sensing unit configuration is associated with a duration of applying the sensing unit configuration.

According to an embodiment, the control may comply with step 3540 of and include (a) activating the multiple sensing elements before starting to receive the reflections, and (b) selectively deactivating at least some of the multiple sensing elements, based on a scan direction of the scan segment, thereby reducing a number of active sensing elements during the scan segment time window.

According to an embodiment, the control differs from step 3540. Examples of control schemes that differ from the example of step 3540 are illustrated in FIGS. 19, 21, 22, 28 and 29. For example—a sensing unit may be activated (during the scan segment time window) after another sensing unit is deactivated (during the same scan segment time window).

A non-transitory computer readable medium that stores instruction that once executed by a LIDAR system, causes the LIDAR system to: (i) transmit, by optics of the LIDAR system, using a scanner, a transmitted signal; (ii) receive, by the optics and using the scanner, reflections from objects, during a scan segment time window that corresponds to a scan segment of a field of view (FOV) of the LIDAR system; (iii) sense the reflections by a sensing unit of the LIDAR system, the sensing unit includes multiple sensing elements; and (iv) selectively control, by a controller of the LIDAR system, a state of activation of sets of sensing elements, out of the plurality of sets of sensing elements, during the scan segment time window, based on a sequence of sensing unit configurations, each sensing unit configuration is associated with a duration of applying the sensing unit configuration.

Any reference to vertical and horizontal is applicable mutatis mutandis to any other directions.

Any reference to a method should be applied mutatis mutandis to a non-transitory computer readable medium that stores instructions for executing the method and/or should be applied mutatis mutandis to a system or a device or a unit that is configured to execute the method.

Any reference to a system or a device or a unit should be applied mutatis mutandis to a non-transitory computer readable medium that stores instructions executable by the system or a device or a unit, and/or should be applied mutatis mutandis to a method executable by the system or a device or a unit.

Any reference to a non-transitory computer readable medium should be applied mutatis mutandis to a method for executing instructions stored in the non-transitory computer readable medium and/or should be applied mutatis mutandis to a system or a device or a unit that is configured to execute the instructions stored in the non-transitory computer readable medium.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of . Net Framework, . Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A LIDAR system, comprising:
optics configured to (a) transmit, using a scanner, a transmitted signal, and (b) receive, using the scanner, reflections from objects, during a scan segment time window that corresponds to a scan segment of a field of view (FOV) of the LIDAR system;
a sensing unit that comprises multiple sensing elements; and
a controller that is arranged to (a) activate the multiple sensing elements before starting to receive the reflections, and (b) selectively deactivate at least some of the multiple sensing elements, based on a scan direction of the scan segment, thereby reducing a number of active sensing elements during the scan segment time window.

2. The LIDAR system according to claim 1, wherein the multiple sensing elements comprise a plurality of sets of sensing elements, wherein the controller is configured to selectively deactivate sets of sensing elements, out of the plurality of sets of sensing elements.

3. The LIDAR system according to claim 2, wherein each set of sensing elements is a line of groups of sensing elements.

4. The LIDAR system according to claim 2, wherein each set of sensing elements comprises a plurality of lines of groups of sensing element segments, wherein at least two of the plurality of lines of groups of sensing element segments are shifted from each other.

5. The LIDAR system according to claim 4, wherein the lateral shift between the at least two of the plurality of groups of sensing elements segment is selected for compensating for sensor unit misalignment.

6. The LIDAR system according to claim 2, wherein controller is configured to selectively deactivate the sets of the sensing elements based at least in part on a sequence of sensing unit configurations, each sensing unit configuration is associated with a duration of applying the sensing unit configuration.

7. The LIDAR system according to claim 6, wherein at least one sensing unit configuration is based on a fixed allocation of sensing elements per set of sensing elements.

8. The LIDAR system according to claim 6, wherein at least one sensing unit configuration is based on a dynamic allocation of sensing elements per set of sensing elements.

9. The LIDAR system according to claim 8, wherein the dynamic allocation is responsive to misalignment related changes of locations of reflection.

10. The LIDAR system according to claim 6, comprising a local memory unit that stores configuration information that defines the sequence of sensing unit configurations.

11. The LIDAR system according to claim 1, wherein the reducing of the number of active sensing elements is determined based on instantaneous signal to noise ratio (SNR) associated with the active sensing elements.

12. The LIDAR system according to claim 1, wherein the transmitted signal is a single beam of light.

13. The LIDAR system according to claim 1, wherein the transmitted signal comprises multiple beams of light.

14. The LIDAR system according to claim 1, wherein the FOV of the LIDAR system is scanned by multiple scan segments.

15. The LIDAR system according to claim 14, wherein there are at least two scan segments of the multiple scan segments that exhibit a same scan direction.

16. The LIDAR system according to claim 14, wherein there are at least two scan segments of the multiple scan segments that exhibit different scan directions.

17. The LIDAR system according to claim 1, wherein the scanner is configured to output the transmitted signal, along a transmission optical axis, and to receive the reflections along one or more reception optical axes that are substantially parallel to the transmission optical axis.

18. The LIDAR system according to claim 17, wherein for each reflection of the reflections, an angular difference between the transmission optical axis and a reception optical axis associated with the reflection does not exceed an angular difference associated with a scanner state difference between (a) a scanner state during a transmission of the transmitted signal and (b) a scanner state during a reception of the reflection.

19. A method for operating a LIDAR system, the method comprising:
transmitting, by optics of the LIDAR system, using a scanner, a transmitted signal;
receiving, by the optics and using the scanner, reflections from objects, during a scan segment time window that corresponds to a scan segment of a field of view (FOV) of the LIDAR system;
sensing the reflections by a sensing unit of the LIDAR system, the sensing unit comprises multiple sensing elements; and
controlling the sensing unit by a controller, wherein the controlling comprises (a) activating the multiple sensing elements before starting to receive the reflections, and (b) selectively deactivating at least some of the multiple sensing elements, based on a scan direction of the scan segment, thereby reducing a number of active sensing elements during the scan segment time window.

20. A non-transitory computer readable medium that stores instruction that once executed by a LIDAR system, causes the LIDAR system to:
transmit, by optics of the LIDAR system, using a scanner, a transmitted signal;
receive, by the optics and using the scanner, reflections from objects, during a scan segment time window that corresponds to a scan segment of a field of view (FOV) of the LIDAR system;
sense the reflections by a sensing unit of the LIDAR system, the sensing unit comprises multiple sensing elements; and
control the sensing unit by a controller, wherein the controlling comprises (a) activating the multiple sensing elements before starting to receive the reflections, and (b) selectively deactivating at least some of the multiple sensing elements, based on a scan direction of the scan segment, thereby reducing a number of active sensing elements during the scan segment time window,

21-60. (canceled)
